(19) United States
(12) Patent Application Publication
(10) Pub. No.: US 2024/0166184 A1
(43) Pub. Date: May 23, 2024

(54) BRAKE ARRANGEMENT FOR A TRACKED VEHICLE

(71) Applicant: BAE Systems Hägglunds Aktiebolag, Örnsköldsvik (SE)

(72) Inventors: Max THORÉN, Örnsköldsvik (SE); Björn HELLHOLM, Arnäsvall (SE); Filip BYBERG, Linköping (SE)

(73) Assignee: BAE Systems Hägglunds Aktiebolag, Örnsköldsvik (SE)

(21) Appl. No.: 18/551,570

(22) PCT Filed: Mar. 24, 2022
(86) PCT No.: PCT/SE2022/050284

§ 371 Date: Sep. 20, 2023

(30) Foreign Application Priority Data
Mar. 25, 2021 (SE) 2150356-0

(51) Int. Cl. B60T 13/22; B60T 1/06; B60T 17/22; B62D 55/06; F16D 55/40; F16D 65/12; F16D 65/18; F16D 65/38; F16D 65/44; F16D 121/04; F16D 121/06

(52) U.S. Cl. CPC B60T 13/22; B60T 1/062; B60T 17/22; F16D 55/40; F16D 65/123; F16D 65/186; F16D 65/44; B62D 55/06; F16D 2065/383; F16D 2121/04; F16D 2121/06

(57) ABSTRACT

Disclosed is a brake arrangement for a tracked vehicle. The brake arrangement comprises a brake housing. Said brake arrangement is journaled in bearings in connection to a drive unit driven drive axle configured to rotate a drive wheel member. Said brake arrangement comprises a set of ring shaped friction elements arranged about said drive axle and configured to be pressed together in the axial direction for providing a braking function. Said set of friction elements comprises a first end friction element being the outermost friction element against which pressure is configured to be provided for said braking function. Said first end friction element has a thickness in the axial direction which is thicker than the remaining set of friction elements so as to facilitate distributing an even pressure on said set of friction elements when said set of friction elements are pressed together for efficient friction braking function.

### CROSS-REFERENCE TO RELATED APPLICATIONS

This application is a U.S. national stage application under 35 U.S.C. § 371 of International Application No. PCT/SE2022/050284, filed Mar. 24, 2022, which claims the priority of SE Application No. 2150356-0, filed Mar. 25, 2021, the entire contents of each priority application is incorporated herein by reference.

### FIELD OF THE DISCLOSURE

The present invention relates to a brake arrangement for a tracked vehicle. The present invention relates to a track assembly comprising such a brake arrangement. The present invention relates to a tracked vehicle comprising at least one such track assembly.

### BACKGROUND OF THE DISCLOSURE

Tracked vehicles may comprise a pair of track assemblies, where each track assembly of the pair of track assemblies comprises a track support beam, a drive wheel member, a plurality of road wheels and an endless track running over the drive wheel member and said plurality of road wheels. Said drive wheel member and said plurality of road wheels are rotatably secured to said track support beam. A drive member is configured to drive a drive axle which in turn is configured to rotate said drive wheel member which is arranged to drive said endless track so as to propel the tracked vehicle. In order to provide a braking function for stopping drive of such a tracked vehicle, a brake arrangement may be arranged in connection to said drive axle and drive wheel member.

There is a need to present improvements for brake arrangements for tracked vehicles.

### OBJECTS OF THE INVENTION

An object of the present invention is to provide a brake arrangement for a tracked vehicle which facilitates providing an efficient braking function for efficient braking of said brake arrangement in connection to a brake action of a tracked vehicle.

Another object of the present invention is to provide a track assembly for a tracked vehicle comprising such a brake arrangement.

Another object of the present invention is to provide a tracked vehicle with at least one such track assembly.

### SUMMARY OF THE DISCLOSURE

These and other objects, apparent from the following description, are achieved by a brake arrangement for a tracked vehicle, a track assembly for a tracked vehicle, and a tracked vehicle as set out in the appended independent claims. Preferred embodiments of the brake arrangement are defined in appended dependent claims.

Specifically an object of the invention is achieved by a brake arrangement for a tracked vehicle. The brake arrangement comprises a brake housing. Said brake arrangement is configured to be journaled in bearings in connection to a drive member driven drive axle so as to allow rotation of said drive axle relative to said brake housing. Said drive axle is configured to rotate a drive wheel member for a track assembly of a tracked vehicle. Said brake arrangement comprises a set of friction elements configured to be arranged about said drive axle, said set of friction elements being configured to be pressed together in the axial direction for providing a braking function in connection to said drive axle. Said set of friction elements comprises a first end friction element being the outermost friction element against which pressure is configured to be provided for said braking function. Said first end friction element has a thickness in the axial direction which is thicker than the remaining set of friction elements so as to facilitate distributing an even pressure on said set of friction elements when said set of friction elements are pressed together for efficient friction braking function. Said set of friction elements are configured to be arranged about said drive axle axially in relation to each other. Said first end friction element is the axially outermost friction element. Said first end friction element is the axially outermost friction element at the end from which pressure is configured to be provided. According to an aspect of the present disclosure, said first end friction element has a thickness in the axial direction which is thicker than any of the other friction elements of the set of friction elements. According to an aspect of the present disclosure, each of the other friction elements of the set of friction elements has essentially the same axial thickness.

By thus providing a brake arrangement with a set of friction elements arranged around a drive axle and having a thicker end friction element, distribution of an even pressure on the set of friction elements is facilitated, wherein an efficient braking function may be provided for efficient braking of said brake arrangement in connection to a brake action. By thus providing said first end friction element with a thickness in the axial direction which is thicker than the individual thickness in the axial direction of the respective remaining set of friction elements, said first end element will to a higher extent resist pressure such that the shape of the first end friction element will remain essentially the same, facilitating distributing a more even pressure on said set of friction elements when said set of friction elements are pressed together for efficient friction braking function. By thus providing a brake arrangement with a set of friction elements arranged around a drive axle and having a thicker axially outermost end friction element, distribution of an even pressure on the set of friction elements is facilitated in such a way that axial pressure against said axially outer most friction element by means of e.g. a piston can be non-central, e.g. at a radially outer periphery radially towards the inner side of said of the outer most friction element and still obtain an even pressure transfer. This further facilitates having e.g. both a service piston for service brake function and a parking brake piston for parking brake function acting directly on said outer most friction element at different radial positions with regard to said outer most friction element, with an even pressure for both brake functions.

According to an embodiment said brake arrangement further comprises a hollow brake axle configured to be arranged around said drive axle so that the brake axle is rotated by means of said drive axle, wherein said brake housing is configured to be journaled in bearings to said brake axle such that said journaling in bearings in connection to said drive axle is provided when said brake arrangement is connected to said drive axle. By thus providing a brake arrangement with such a hollow brake axle arranged around said drive axle, a radially compact brake arrangement may be provided, facilitating efficient function of said brake arrangement in connection to braking function associated with drive and/or parking. By thus providing a brake arrangement with such a hollow brake axle arranged around said drive axle, a radially compact drive arrangement in which said brake arrangement is included may be efficiently provided.

According to an aspect of the present disclosure, said set of friction elements comprises a first set of friction elements configured to be engaged to said brake housing, and a second set of friction elements configured to be attached to said to said brake axle for allowing rotation of said second set of friction elements relative to said first set of friction elements, wherein said first set of friction elements and second set of friction elements are axially alternatingly arranged relative to each other.

According to an embodiment said brake arrangement further comprises a bearing configuration for providing said journaling in bearings of said brake housing in connection to said brake axle, said bearing configuration comprising a first bearing member and a second bearing member arranged at an axial distance from said first bearing member, wherein one of said bearing members is provided with a flange configuration for holding the brake housing in the axial direction and the other of said bearing members is configured to allow certain axial movement of said housing relative to said brake axle. By thus providing a brake arrangement with such a bearing configuration with a first and second bearing member axially distanced in connection to said brake axle, a radially compact brake arrangement may be provided. By thus providing a brake arrangement with such a bearing configuration with a first and second bearing member axially distanced in connection to said brake axle, an easy and efficient support of said brake housing and hence brake arrangement is provided, facilitating easy assembly to a drive arrangement of a track assembly and easy disassembly of said brake arrangement from said drive arrangement of said track assembly. By thus providing a brake arrangement with such a bearing configuration with a bearing member provided with a flange configuration for holding the brake housing in the axial direction and the other bearing member axially distanced in connection to said brake axle which allows axial movement of said housing relative to said brake axle, a brake arrangement which may be efficiently suspended, e.g. to the track support beam of said track assembly, e.g. via a suspension arrangement. By thus providing a brake arrangement with such a bearing configuration with a bearing member provided with a flange configuration for holding the brake housing in the axial direction and the other bearing member axially distanced in connection to said brake axle which allows axial movement of said housing relative to said brake axle, a brake arrangement which facilitates safe operation is provided.

According to an embodiment of said brake arrangement, said first bearing member is arranged in connection to a first end portion of said brake housing and said second bearing member is arranged in connection to a second end portion of said brake housing, axially opposite to said first end portion, and wherein said first and second bearing members are cylindrical roller bearing members. Hereby efficient journaling of said brake housing of said brake arrangement is facilitated.

According to an embodiment of said brake arrangement, said brake housing has an end wall portion, wherein said set of friction elements are arranged in connection to said end wall portion such that said end wall portion and set of friction elements provides a friction arrangement for providing said braking. By thus utilizing said end wall portion as a friction arrangement together with said friction elements, an axially compact brake arrangement with efficient braking function may be provided, facilitating arranging said brake arrangement, in the direction essentially perpendicular to the longitudinal direction and the transversal direction of the endless track, within the periphery of the endless track.

According to an embodiment of said brake arrangement, said end wall portion has an inner side facing said set of friction elements such that a second end element of said set of friction elements, farthest away from said first end element, is arranged in connection to said inner side of said end wall portion, such that when said set of friction elements are pressed together in the axial direction for providing a braking function, said second end element is pressed against said inner side of said end wall portion. By thus utilizing said end wall portion as a friction arrangement together with said friction elements, including said second end element closest to said end wall, an axially compact brake arrangement with efficient braking function may be provided. Hereby it is facilitated to arrange said brake arrangement, in the direction essentially perpendicular to the longitudinal direction and the transversal direction of the endless track, within the periphery of the endless track.

According to an embodiment of said brake arrangement, said set of friction elements comprises a first set of elements configured to be engaged to said brake housing and a second set of elements configured to be engaged to said brake axle for allowing rotation of said second set of elements relative to said first set of elements, wherein said first set of elements and second set of elements are alternatingly arranged relative to each other. Hereby an efficient brake function by means of providing friction between said first and second set of elements may be provided. By thus alternatingly arranging said first and second set of elements to brake housing and brake axle, an axially compact brake arrangement with efficient braking function may be provided.

According to an embodiment of said brake arrangement, said brake arrangement further comprising a service brake piston device arranged in connection to said set of friction elements, said service brake piston device being configured to act on said set of friction elements based on a brake action so as to press said elements together for providing a braking function for braking rotation of said drive axle so as to brake drive wheel member for stopping drive of a vehicle provided with said brake arrangement. By thus providing a service brake piston device in connection to said set of friction elements, efficient braking by applying said service brake piston device on said elements may be provided.

According to an embodiment said brake arrangement further comprises a channel configuration within said housing, said channel configuration comprising at least one channel in connection to said service brake piston device, said service brake piston device being configured to receive, in connection to a braking action, pressurized fluid via said at least one channel such that said service brake piston device acts on said set of friction elements. By thus providing such a channel configuration for pressurized fluid for activating said service brake piston device, efficient braking based on a braking action may be safely and easily provided.

According to an embodiment of said brake arrangement, said service brake piston device is ring shaped and configured to be coaxially arranged around said brake axle. Hereby pressure against said set of friction elements may be evenly distributed in an efficient way for efficient braking function.

According to an embodiment said brake arrangement further comprises a parking brake piston device arranged in connection to said set of friction elements, said parking brake piston device being configured to act on said set of friction elements based on a parking brake action indicating parking of a vehicle for pressing said elements together for providing a parking brake function for preventing rotation of said drive axle so as to provide a parking brake activated state, preventing movement of wheel member for keeping a vehicle provided with said brake arrangement in a parked position. By thus providing a parking brake piston device in connection to said set of friction elements, efficient parking braking by applying said parking brake piston device on said elements may be provided. The brake arrangement thus facilitates both service brake function and parking brake function by means of the same set of friction elements. Hereby an axially compact brake arrangement may be provided, facilitating arranging said brake arrangement within said endless track on the outer side of said track support beam of said track assembly.

According to an embodiment of said brake arrangement, said parking brake piston device is ring shaped and configured to be coaxially arranged around said brake axle radially externally relative to said service brake piston device, said parking brake piston device being configured to provide pressure in the axial direction against a radially outer portion of said set of friction elements so as to optimize the parking brake torque. Hereby pressure against said set of friction elements may be evenly distributed in an efficient way for efficient parking brake function. By thus arranging said parking brake piston device externally relative to said service brake piston device so that said parking brake piston device provides pressure in the outer periphery of said set of friction elements, the parking brake torque may be efficiently maximized.

According to an aspect of the present disclosure, said ring shaped service brake piston device is configured to be coaxially arranged around said drive axle radially internally relative to said parking brake piston device, wherein said parking brake piston device is configured to be coaxially arranged around said drive axle in connection to said radially outer portion of said set of friction elements at least partly around said service brake device so that said parking brake piston device is configured to provide pressure in the axial direction directly against said radially outer portion of said set of friction elements. By thus arranging said parking brake piston device externally relative to said service brake piston device, said parking brake piston device provides pressure in the outer periphery of said set of friction elements so that the parking brake torque may be efficiently maximized. This further has the technical effect that said parking brake piston device and service brake piston device may be operated independently of each other. Such an arrangement with said parking brake piston device externally relative to said service brake piston device may facilitate an axially compact solution of said parking brake arrangement.

According to an embodiment said brake arrangement further comprises a spring device arranged in connection to said parking brake piston device, wherein said spring device, in a non-parking brake activated state, is configured to be compressed by means of providing a hydraulic pressure on said spring device so that said parking brake piston device does not act on said set of friction elements, and wherein, in connection to a parking brake action, said hydraulic pressure on said spring device is configured to be removed such that said spring device acts on said parking brake piston device by means of a spring force so that said parking brake piston device acts on said set of friction elements so as to provide a parking brake activated state. Hereby said parking brake activated state may be safely and efficiently provided.

According to an embodiment of said brake arrangement, said parking brake piston device is configured to receive, in connection to a non-parking brake activated state, pressurized fluid via at least one channel of said channel configuration, such that said parking brake piston device acts on said spring device for providing said compressed state of said spring device. Hereby said parking brake activated state may be safely and efficiently provided.

Thus, said parking brake piston device is thus arranged in connection to said set of friction elements and said spring device for facilitating said non-parking brake activated state when subjected to said hydraulic pressure and said parking brake state when said hydraulic pressure is removed.

According to an embodiment of said brake arrangement, in connection to an unexpected loss of hydraulic pressure associated with a parking brake operation of said brake arrangement, said hydraulic pressure providing said compressed state of said spring device is configured to be removed such that said spring device acts on said parking brake piston device by means of a spring force so as to provide a parking brake activated state. Hereby safety of said brake arrangement may be improved in that said parking brake activated state is activated in connection to hydraulic loss.

According to an embodiment of said brake arrangement, said spring device has a ring shaped configuration, said spring device comprising a set of spring members configured to be distributed around said brake axle in connection to said ring shaped parking brake piston device. Hereby spring pressure provided by means of said spring device may be evenly distributed in an efficient way.

According to an embodiment of said brake arrangement, said brake arrangement further comprises an adjustment device arranged in connection to said spring device axially opposite to said parking brake piston device, said adjustment device being configured to facilitate axial adjustment of said spring device based on the axial position of said parking brake piston device. Hereby efficient function of said spring device for efficient parking brake function may be efficiently maintained despite wear.

According to an embodiment of said brake arrangement, said brake arrangement further comprises an opening running from a portion of said housing to said parking brake piston device and configured to receive a measure pin so as to determine position of said parking brake piston device relative to said portion of said housing so as to determine whether there is a need for axial adjustment of said spring device. Hereby wear of friction elements of said set of friction elements may be easily and efficiently determined, so as to facilitate maintaining efficient function of said spring device for efficient parking brake function.

Specifically an object of the invention is achieved by a track assembly comprising a brake arrangement a set out herein.

Specifically an object of the invention is achieved by a tracked vehicle comprising a brake arrangement a set out herein.

Specifically an object of the invention is achieved by a tracked vehicle comprising at least one track assembly comprising a brake arrangement a set out herein.

According to an embodiment, said tracked vehicle comprises a left track assembly, a right track assembly and a vehicle body, wherein said track assemblies are suspendedly arranged to said vehicle body by means of a suspension arrangement.

The tracked vehicle may comprise one or more tracked vehicle units. The tracked vehicle comprises according to an embodiment more than one tracked vehicle unit, said vehicle units being articulately connected to each other.

According to an embodiment, said tracked vehicle is an articulated tracked vehicle comprising a first vehicle unit and a second vehicle unit pivotably connected to the first vehicle unit via an articulation joint, each of said vehicle units comprising a vehicle body and track assembly pair suspendedly connected to respective vehicle body.

### BRIEF DESCRIPTION OF THE FIGURES

For a better understanding of the present disclosure reference is made to the following detailed description when read in conjunction with the accompanying drawings, wherein like reference characters refer to like parts throughout the several views, and in which:

FIG. 1A schematically illustrates a side view of a tracked vehicle comprising track assembly according to an embodiment of the present disclosure;

FIG. 1B schematically illustrates a side view of an articulated tracked vehicle comprising track assemblies according to an embodiment of the present disclosure;

FIG. 2 schematically illustrates a plan view of a tracked vehicle with track assemblies comprising a drive arrangement according to an embodiment of the present disclosure;

FIG. 3A schematically illustrates a perspective view of a pair of track assemblies of a tracked vehicle according to an embodiment of the present invention;

FIG. 3B schematically illustrates a side view of a track assembly in FIG. 3A;

FIG. 4A schematically illustrates a side view of a drive arrangement for a track assembly according to an embodiment of the present disclosure;

FIG. 4B schematically illustrates a side view of the drive arrangement in FIG. 4A connected to a track support beam of a track assembly and being provided with drive wheel member, according to an embodiment of the present disclosure;

FIG. 5 schematically illustrates a perspective view of a drive arrangement connected to a track support beam of a track assembly and being provided with drive wheel member, according to an embodiment of the present disclosure;

FIG. 6 schematically illustrates a cross sectional view of the drive arrangement in FIG. 5, connected to a track support beam of a track assembly and being provided with drive wheel member, according to an embodiment of the present disclosure;

FIG. 7 schematically illustrates a cross sectional view of a brake arrangement of the drive arrangement in FIG. 6, according to an embodiment of the present disclosure;

FIG. 8 schematically illustrates a perspective view of a set of friction elements of the brake arrangement in FIG. 7;

FIG. 9 schematically illustrates an exploded perspective view of the set of friction elements in FIG. 8;

FIG. 10A schematically illustrates a perspective views of a service brake piston device of the brake arrangement in FIG. 7;

FIG. 10B schematically illustrates a perspective views of a service brake piston device of the brake arrangement in FIG. 7;

FIG. 11 schematically illustrates a perspective view of a parking brake piston device of the brake arrangement in FIG. 7;

FIG. 12A schematically illustrates a perspective view of a spring device of the brake arrangement in FIG. 7 in connection to the parking brake piston device in FIG. 11;

FIG. 12B schematically illustrates a perspective view of a spring device of the brake arrangement in FIG. 7 in connection to the parking brake piston device in FIG. 11; and

FIG. 13 schematically illustrates a cross sectional view of a portion of the brake arrangement in FIG. 7 with an adjustment device of the brake arrangement according to an embodiment of the present disclosure;

### DETAILED DESCRIPTION OF THE DISCLOSURE

Hereinafter the term “track support beam” refers to a structural element arranged to support ground-engaging means such as e.g. an endless track as well as drive wheel member and road wheels.

Hereinafter the term “track assembly” refers to a unit of the tracked vehicle comprising track support beam, drive wheel member and road wheels as well as a circumferential endless track, which unit is arranged to comprise ground-engaging means and configured to propel the vehicle and thus form at least part of a drive configuration of the tracked vehicle.

Hereinafter the term “track assembly pair” refers to opposite track assemblies of a vehicle unit of the vehicle, one track assembly constituting a right track assembly and the opposite track assembly constituting a left track assembly.

Hereinafter the term “articulated vehicle” refers to a vehicle with at least a front and a rear vehicle unit, which vehicle units are pivotable relative to each other about at least one joint.

Hereinafter the term “vehicle body” refers to any structure of a vehicle configured to be supported by track assemblies of a tracked vehicle and may comprise or constitute the vehicle chassis. The term “vehicle body” may refer to a vehicle frame, one or more beams or the like. The term “vehicle body” may refer to chassis of the vehicle and bodywork.

Hereinafter the term “centre axis”, when referring to said drive wheel member being configured to be rotated about a centre axis, refers to the axis about which a drive wheel member of a track assembly is configured to rotate, and hence to an axis running in the transversal direction and perpendicular to the longitudinal direction of the endless track of said track assembly.

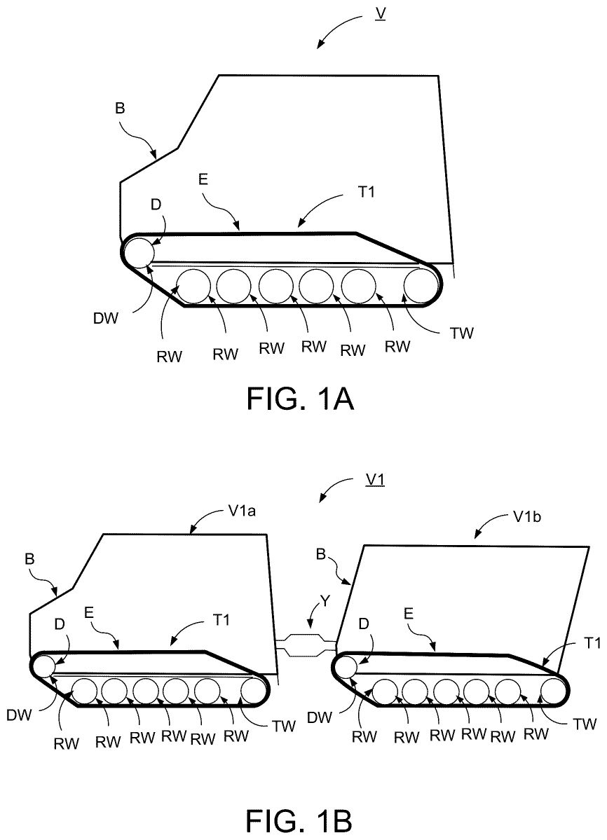

FIG. 1A schematically illustrates a side view of a tracked vehicle V according to an embodiment of the present disclosure.

The tracked vehicle V comprises a vehicle body B, which according to an aspect of the present disclosure comprises the chassis of the vehicle V and bodywork.

The tracked vehicle V comprises a left track assembly T1 and a right track assembly for driving the vehicle V, the left track assembly T1 being shown in FIG. 1A. Each track assembly comprises a drive wheel member DW, a tension wheel TW, a set of road wheels RW and an endless track E arranged to run over said wheels. The endless track E is thus arranged to be disposed around said wheels. Here the drive wheel member DW is arranged in the front, the tension wheel TW is arranged in the back and the road wheels RW are arranged between the drive wheel member DW and the tension wheel TW. The tracked vehicle according to the present disclosure may however have track assemblies with any suitable arrangement of drive wheel member, tension wheel and road wheels. According to an aspect of the present disclosure the tension wheel may be arranged in the front, the drive wheel member arranged in the back and the road wheels arranged there between.

The endless track E of the respective track assembly is arranged to be driven and hence rotated by means of said drive wheel member DW. The respective track assembly T1 of the tracked vehicle V comprises a drive arrangement D for operating and hence driving said drive wheel member DW. The drive arrangement D is configured to be coaxially arranged relative to the drive wheel member DW.

FIG. 1B schematically illustrates a side view of a tracked vehicle V1 according to an embodiment of the present disclosure.

Said tracked vehicle V1 is an articulated tracked vehicle V1 comprising a first vehicle unit V1a and a second vehicle unit V1b pivotably connected to the first vehicle unit V1a via an articulation joint Y. Each of said vehicle units V1a, V1b comprises a vehicle body B and track assembly pair T1 suspendedly connected to respective vehicle body B, the left track assembly T1 of the respective vehicle unit V1a, V1b being shown.

Each track assembly comprises a drive wheel member DW, a tension wheel TW, a set of road wheels RW and an endless track E arranged to run over said wheels. The endless track E is thus arranged to be disposed around said wheels. Here the drive wheel member DW is arranged in the front, the tension wheel TW is arranged in the back and the road wheels RW are arranged between the drive wheel member DW and the tension wheel TW.

The endless track E of the respective track assembly of the respective vehicle unit V1a, V1b of said tracked vehicle V1 is arranged to be driven and hence rotated by means of said drive wheel member DW. The respective track assembly T1 of the vehicle units V1a, V1b of said tracked vehicle V1 may comprise a drive arrangement D for operating and hence driving said drive wheel member DW. The drive arrangement D is configured to be coaxially arranged relative to the drive wheel member DW.

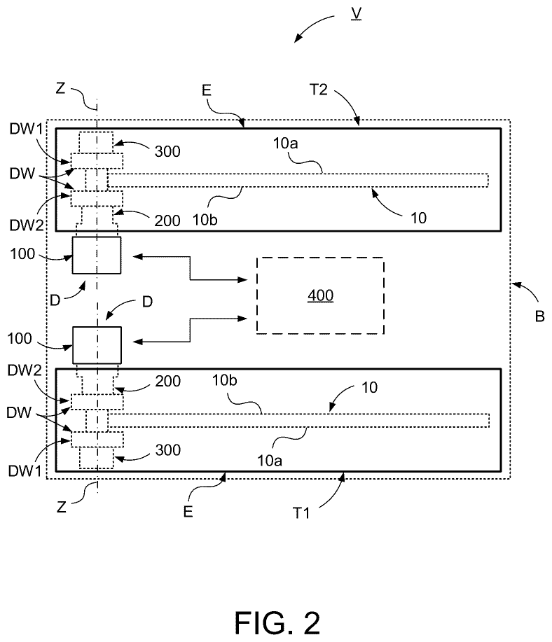

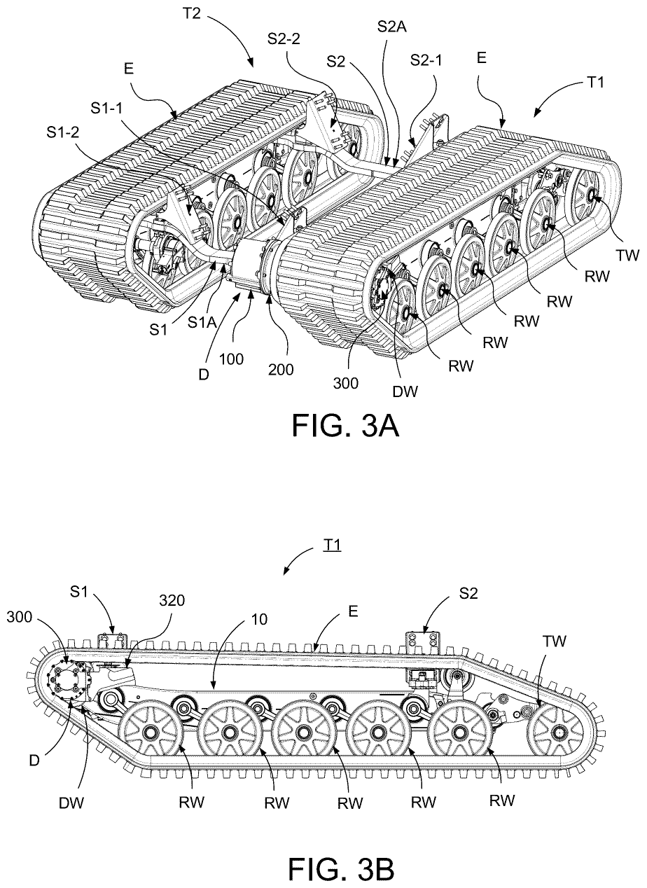

FIG. 2 schematically illustrates a plan view of the tracked vehicle V in FIG. 1A according to an embodiment of the present disclosure. FIG. 3A schematically illustrates a perspective view of a track assembly pair T1, T2 of a tracked vehicle and FIG. 3B schematically illustrates a side view of the left track assembly T1 in FIG. 3A.

The tracked vehicle V comprises a left track assembly T1, a right track assembly T2 and a vehicle body B. The left and right track assemblies T1, T2 provides a track assembly pair T1, T2. Said tracked vehicle V is thus configured to comprises a pair of track assemblies T1, T2 configured to be arranged to suspendedly support said vehicle body B of said vehicle so as to allow relative movement between said vehicle body B and each track assembly T1, T2. The respective track assembly T1, T2 has a longitudinal extension configured to run in the longitudinal extension of the vehicle V, when assembled to the vehicle body B.

Said track assemblies T1, T2 are suspendedly arranged to said vehicle body by means of a suspension arrangement S1, S2, see e.g. FIG. 3A. The suspension arrangement according to the present disclosure may be any suitable suspension arrangement for suspendedly support said vehicle body.

The left and right track assemblies T1, T2 of said track assembly pair T1, T2 comprises a track support beam 10 configured to support a plurality of road wheels, not shown in FIG. 2, a drive wheel member DW, and a drive arrangement D for operating said drive wheel member DW. The left track assembly T1 comprises a track support beam 10 configured to support a plurality of road wheels, a drive wheel member DW, and a drive arrangement D. The right track assembly T2 comprises a track support beam 10 configured to support a plurality of road wheels, a drive wheel member DW, and a drive arrangement D. The left and right track assemblies T1, T2 of said track assembly pair T1, T2 comprises an endless track E being disposed around said road wheels and drive wheel member DW. The track support beam 10 of the respective track assembly T1, T2 has a longitudinal extension configured to run in the longitudinal extension of the vehicle V, when the track assembly is assembled to the vehicle body B.

According to an aspect of the present disclosure, e.g. as illustrated in FIG. 3A, the suspension arrangement S1, S2 has a leaf spring configuration.

According to an aspect of the present disclosure, said suspension device S1, S2 comprises a front leaf spring element S1 being transversally arranged relative to the longitudinal extension of the tracked vehicle V in the front portion of said vehicle between the left track assembly T1 and right track assembly T2. Said front leaf spring element S1 is arranged between said left and right track assemblies T1, T2 in connection to the track support beam 10 of the respective track assembly T1, T2. Said front leaf spring element S1 is connected in a first end portion to the track support beam 10 of the left track assembly T1 and connected in an opposite second end portion to the track support beam 10 of the right track assembly. The first end portion of the front leaf spring element S1 is connected to a front part of the track support beam 10 of the left track assembly T1 in connection to said drive wheel member and drive arrangement D of the left track assembly T1. The second end portion of the front leaf spring element S1 is connected to a front part of the track support beam 10 of the right track assembly T2 in connection to said drive wheel member and drive arrangement of the right track assembly T1.

According to an aspect of the present disclosure, said front leaf spring element S1 has a U-shaped configuration S1A having double bending portions/transitions with double bending portions configured to be arranged in connection to the respective side of the vehicle body, and an under portion arranged to run underneath the vehicle body, the vehicle body not being shown in FIG. 3A. The front leaf spring element S1 comprises a first attachment member S1-1 arranged in connection to a first bending portion and a second attachment member S1-2 arranged in connection to an opposite second bending portion of the U-shaped configuration S1A. Said first attachment member S1-1 and second attachment member S1-2 are configured to provide attachment for said vehicle body, not shown in FIG. 3A. The U-shaped configuration S1A is further configured to laterally project from each side of the vehicle body and being attached to the track support beam 10 of the left and right track assembly T1, T2.

According to an aspect of the present disclosure, said suspension device S1, S2 comprises a rear leaf spring element S2 being transversally arranged relative to the longitudinal extension of the tracked vehicle V in the front portion of said vehicle between the left track assembly T1 and right track assembly T2. Said rear leaf spring element S2 is arranged between said left and right track assemblies T1, T2 in connection to the track support beam 10 of the respective track assembly T1, T2. Said rear leaf spring element S2 is connected in a first end portion to the a rear part of track support beam 10 of the left track assembly T1 and connected in an opposite second end portion to a rear part of the track support beam 10 of the right track assembly.

According to an aspect of the present disclosure, said rear leaf spring element S2 has a U-shaped configuration S2A having double bending portions/transitions with double bending portions configured to be arranged in connection to the respective side of the vehicle body, and an under portion arranged to run underneath the vehicle body, the vehicle body not being shown in FIG. 3A. The rear leaf spring element S2 comprises a first attachment member S2-1 arranged in connection to a first bending portion and a second attachment member S2-2 arranged in connection to an opposite second bending portion of the U-shaped configuration S2A. Said first attachment member S2-1 and second attachment member S2-2 are configured to provide attachment for said vehicle body, not shown in FIG. 3A. The U-shaped configuration S2A is further configured to laterally project from each side of the vehicle body and being attached to the track support beam 10 of the left and right track assembly T1, T2.

According to an aspect of the present disclosure, not shown, said suspension arrangement may comprises a leaf spring arrangement having portions transversally arranged relative to the longitudinal extension of the vehicle, where said leaf spring arrangement comprises L-shaped leaf spring members, each leaf spring member having a first portion attached to the vehicle body, a second portion attached to the track support beam and a transition portion there between, so that compressive and tensile stresses are located to said transition portion.

Said drive wheel member DW is configured to be rotated about a centre axis Z. The drive arrangement D of the respective track assembly T1, T2 is configured to be coaxially arranged relative to said centre axis Z of said drive wheel member DW. The drive arrangement D of the respective track assembly T1, T2 has a main direction of extension essentially orthogonal to the longitudinal direction of said endless track and essentially parallel to the transversal direction of said endless track E.

The drive arrangement D of the respective track assembly T1, T2 comprises a motor device 100 for driving said drive wheel member DW, a transmission device 200 for transferring torque from said motor device 100 to said drive wheel member DW and a brake arrangement 300 for braking the drive wheel member DW. Said motor device 100 may comprise an electric motor or a hydraulic motor. Said motor device 100 is described in more

As schematically illustrated in FIG. 2, the drive arrangement D of the respective track assembly T1, T2 may be operably connected to a power supply arrangement 400 for providing power for operating the drive arrangement D the respective track assembly T1, T2. The power supply arrangement 400 may be any suitable power supply arrangement for supplying power to drive arrangement D, i.e. supplying power to motor device 100 of said drive arrangement D.

According to an aspect of the present disclosure, said power supply arrangement 400 may comprise an internal combustion engine. According to an aspect of the present disclosure, the internal combustion engine may be constituted by a diesel engine.

According to an alternative aspect of the present disclosure, said power supply arrangement 400 may comprise an energy supply arrangement such as a battery supply arrangement and/or a fuel cell arrangement, e.g. hydrogen fuel cells.

According to an aspect of the present disclosure, said power supply arrangement 400 may comprise one or more generator units for generating high voltage. One or more control devices, e.g. electronic control units, are provided for controlling, e.g. for each drive arrangement D, said one or more control devices comprising one or more control devices configured to receive high voltage from generator units and transfer said high voltage to drive voltage, i.e. alternating voltage, for said motor device 100 of said drive arrangement D. Said power supply arrangement 400 is according to an aspect of the present disclosure configured to provide a D.C. bus configured to distribute power, i.e. voltage, to e.g. each drive arrangement D. [

For a tracked vehicle in the shape of an articulated tracked vehicle having a front vehicle unit and a rear vehicle unit, e.g. as illustrated in FIG. 1B, such a power supply 400 may be arranged in the front vehicle unit or the rear vehicle unit or in both the front vehicle unit and the rear vehicle unit.

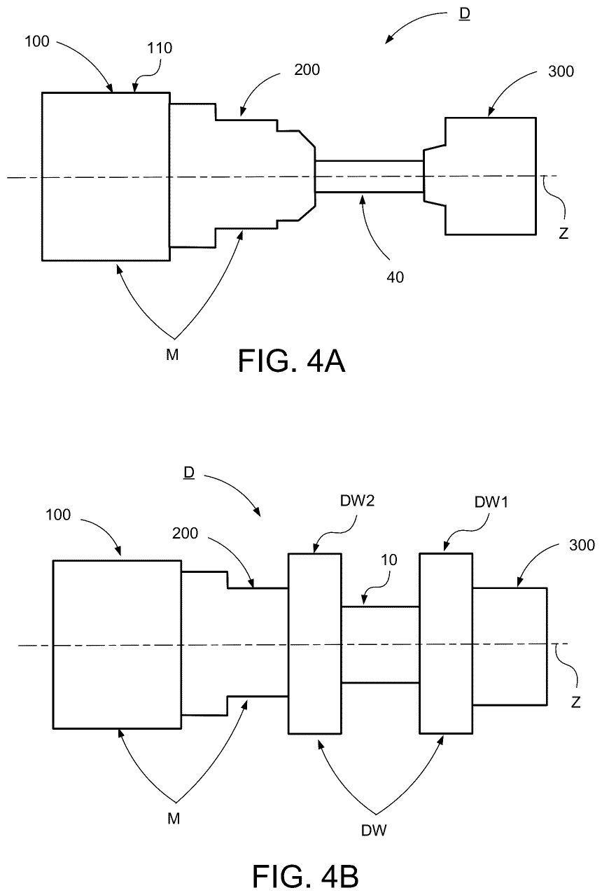

FIG. 4A schematically illustrates a side view of said drive arrangement D and FIG. 4B schematically illustrates a side view of said drive arrangement D supported by said track support beam 10 according to an aspect of the present disclosure.

In FIG. 4B, said drive arrangement D is journaled in bearings to said track support beam 10. In FIG. 4B, said drive arrangement D is operably supporting said drive wheel member DW.

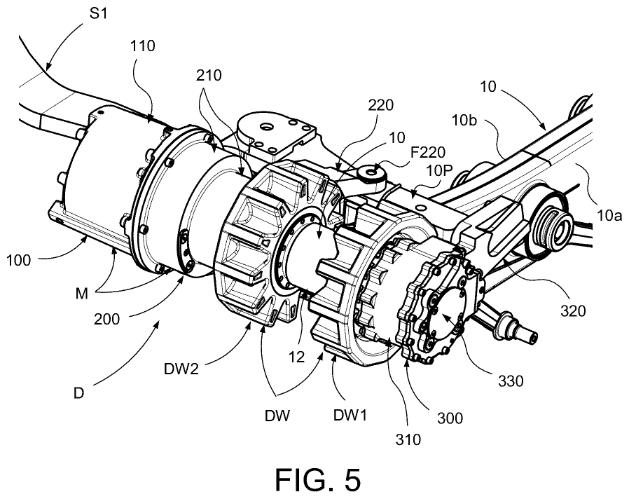

FIG. 5 schematically illustrates a perspective view of said drive arrangement D journaled in bearings to said track support beam 10, operably supporting said drive wheel member DW.

Said drive arrangement D is thus configured to be journaled in bearings in said track support beam 10 for allowing rotation of said drive wheel member DW relative to said track support beam 10 and for supporting said drive arrangement D.

As illustrated in FIG. 2 and FIG. 5, said track support beam 10 has an outer side 10a configured to face away from the vehicle body B and an opposite inner side 10b configured to face towards said vehicle body when the track assembly is connected to said vehicle body B. Herein, when referring to said track support beam 10 having an outer side 10a configured to face away from the vehicle body B and an opposite inner side 10b configured to face towards said vehicle body when the track assembly is connected to said vehicle body B, it refers to a portion of the vehicle body B, e.g. vehicle chassis, arranged between the right and left track assembly and hence right and left drive wheel member. Thus, said track support beam 10 has an outer side 10a facing in a transversal direction of the vehicle V, and transversal direction relative to its longitudinal extension, outwardly away from the opposite track assembly and, and an opposite inner side 10b facing in a transversal direction of the vehicle V, and transversal direction relative to its longitudinal extension, inwardly towards the opposite track assembly.

As schematically illustrated in FIG. 2, the outer side 10a of the track support beam 10 of the left track assembly T1 of the tracked vehicle V is configured to face away from the right track assembly T2 of the tracked vehicle V. As schematically illustrated in FIG. 2, the outer side 10a of the track support beam 10 of the right track assembly T2 of the tracked vehicle V is configured to face away from the left track assembly T1 of the tracked vehicle V.

As schematically illustrated in FIG. 2, the inner side 10b of the track support beam 10 of the left track assembly T1 of the tracked vehicle V is configured to face the right track assembly T2 of the tracked vehicle V. As schematically illustrated in FIG. 2, the inner side 10b of the track support beam 10 of the right track assembly T2 of the tracked vehicle V is configured to face the left track assembly T1 of the tracked vehicle V.

Said drive wheel member DW comprises an outer drive wheel DW1 arranged in connection to the outer side of the track support beam 10 and an inner drive wheel DW2 arranged in connection to the inner side of the track support beam 10.

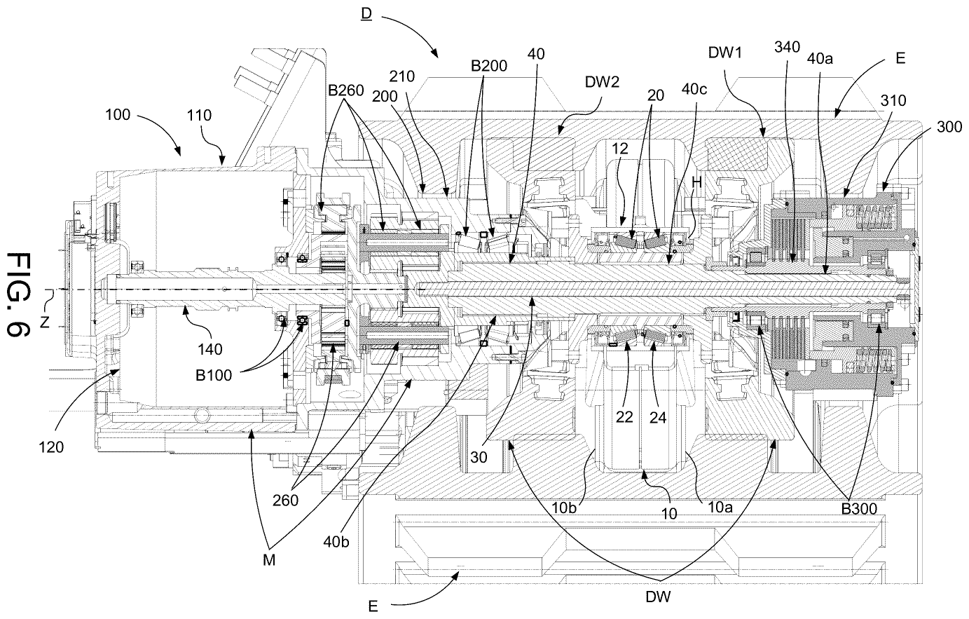

FIG. 6 schematically illustrates a cross sectional view of said drive arrangement D supported by said track support beam 10 according to an aspect of the present disclosure. The cross section is in the axial direction, i.e. the direction of the axis Z. Said drive arrangement D is journaled in bearings to said track support beam 10.

Said drive arrangement D comprises a drive axle 40 for driving said drive wheel member DW. Said drive wheel member DW is configured to be operably connected to said drive axle 40. Said drive wheel member DW is according to an aspect of the present disclosure configured to be connected to said drive axle 40 by means of a splines connection.

The track assembly for the respective drive arrangement D comprises a bearing configuration 20 arranged in said track support beam 10 for providing bearing of said drive arrangement D. According to an aspect of the present disclosure, the track support beam 10 has a front portion 12 in which said bearing configuration 20 is configured to be arranged. According to an aspect of the present disclosure, the front portion 12 of the track support beam 10 has a through hole H. The centre of said through hole H will correspond to the centre axis Z when the drive arrangement D and drive wheel member DW is connected to the track support beam 10.

The bearing configuration 20 is configured to be arranged in said through hole H of the front portion 12 of the track support beam 10. According to an aspect of the present disclosure, said bearing configuration 20 is a tapered roller bearing device. According to an aspect of the present disclosure, said bearing configuration 20 comprises a first roller bearing 22 and an opposite second roller bearing 24. According to an aspect of the present disclosure, first roller bearing 22 and second roller bearing 24 are arranged in connection to each other within said through hole H of the front portion 12 of the track support beam 10 so as to optimize facilitating tipping torque of said drive arrangement D. According to an aspect of the present disclosure, said first roller bearing 22 and second roller bearing 24 are configured to be arranged in connection to each other within said through hole H of the front portion 12 of the track support beam 10 such that there is a certain pre-tension in said roller bearings 22, 24 of said bearing configuration 20. According to an aspect of the present disclosure, said tapered roller bearing device comprises said first roller bearing 22 and an opposite second roller bearing 24.

Said drive axle 40 of the drive arrangement D is configured to run through said through hole H of the front portion 12 of the track support beam 10 in connection to said bearing configuration 20. According to an aspect of the present disclosure, the drive axle 40 is configured to be connected to the bearing configuration 20 by means of a splines connection so that said drive axle 40 may be rotated relative to said track support beam 10.

Said drive axle 40 of the drive arrangement D is configured to run through said through hole H of the front portion 12 of the track support beam 10 so that a portion 40a of the drive axel 40 is protruding in the axial direction from said through hole in connection to the outer side 10a of said track support beam 10. According to an aspect of the present disclosure, said outer drive wheel DW1 is configured to be attached to a portion of the drive axle 40 protruding in the axial direction from the outer side of said track support beam 10.

Said drive axle 40 of the drive arrangement D is configured to run through said through hole H of the front portion 12 of the track support beam 10 so that a portion 40b of the drive axel 40 is protruding in the axial direction from said through hole in connection to the inner side 10b of said track support beam 10. According to an aspect of the present disclosure, said inner drive wheel DW2 is configured to be attached to a portion of the drive axle 40 protruding in the axial direction from the inner side of said track support beam 10.

According to an aspect of the present disclosure, said drive axle 40 is running transversely relative to the longitudinal extension of said track support beam 10 through said through hole H. According to an aspect of the present disclosure, said drive axle 40 has a transversal extension with a central portion 40c configured to be arranged in said through hole and connected to said bearing configuration for said journaling in bearings within the front portion 12 of said track support beam 10.

According to an aspect of the present disclosure, said drive axle 40 with said transversal extension with said central portion 40c has an outer extension 40a configured to protrude in the axial direction outwardly from said track support beam into said brake arrangement 300. Said drive axle 40 with said transversal extension with said central portion 40c has an inner extension 40b configured to protrude in the axial direction inwardly from said track support beam into said transmission device 200.

Said bearing configuration 20 is thus, according to an aspect of the present disclosure, arranged in a through hole H of said track support beam 10, centrally between said outer drive wheel DW1 and inner drive wheel DW2.

Said outer drive wheel DW1 and inner drive wheel DW2 are coaxially arranged relative to each other at a distance along the axis Z from each other, wherein said front portion 12 of said track support beam is arranged between said outer drive wheel DW1 and inner drive wheel DW2 such that said through hole H is arranged between said outer drive wheel DW1 and inner drive wheel DW2 coaxially with said axis Z.

According to an aspect of the present disclosure, said drive arrangement D is supported between said outer drive wheel DW1 and inner drive wheel DW2 in said through hole H of said outer portion 12 of said track support beam 10. Said drive axle 40 of said drive arrangement D is supported between said outer drive wheel DW1 and inner drive wheel DW2 in said through hole H of said outer portion 12 of said track support beam 10.

According to an aspect of the present disclosure, said drive arrangement D is supported between said outer drive wheel DW1 and inner drive wheel DW2 in said through hole H of said outer portion 12 of said track support beam 10 by means of supporting said drive axle 40 of said drive arrangement D with said bearing configuration 20. Said bearing configuration 20 is thus arranged in said through hole H of said track support beam 10, centrally between said outer drive wheel DW1 and inner drive wheel DW2.

As mentioned above, the drive arrangement D comprises a motor device 100 for driving said drive wheel member DW, a transmission device 200 for transferring torque from said motor device 100 to said drive wheel member DW and a brake arrangement 300 for braking the drive wheel member DW.

According to an aspect of the present disclosure, said brake arrangement 300 is configured to be arranged in connection to the outer side 10a of said track support beam 10.

According to an aspect of the present disclosure, said transmission device 200 is configured to be arranged in connection to the inner side 10b of said track support beam 10 and said motor device 100 is configured to be arranged internally relative to said transmission device 200 so that said transmission device 200 is arranged between the motor device 100 and brake arrangement 300.

Said motor device 100 may comprise an electric motor or a hydraulic motor. Said motor device 100 comprises a motor housing 110 for housing parts associated with said motor device 100. Said motor device 100 comprises a motor 120 for said driving. Said motor 120 is configured to be housed in said housing 110.

According to an aspect of the present disclosure, said motor comprises a stator configured to be fixedly connected to said motor housing 110 of said motor 100, and a rotor for providing a rotational movement of a motor axle 140 relative to the stator.

According to an aspect of the present disclosure, a power supply, e.g. a power supply 400 schematically illustrated in FIG. 2, may be configured to provide power for said motor device 100, i.e. for operating said rotor 120a of said motor 120 and hence said motor axle 140.

The motor device comprises a bearing configuration B100 arranged in said motor housing 110 of said motor device 100 for providing bearing of said motor axle 140. According to an aspect of the present disclosure, said bearing configuration B100 is a deep groove ball bearing device. According to an aspect of the present disclosure, the motor axle 140 is configured to be connected to the bearing configuration B100 by means of a splines connection so that said motor axle 140 may be rotated relative to said motor housing 110.

According to an aspect of the present disclosure, said motor axle 140 is configured to be operably connected to said transmission device 200 for transferring torque from said motor axle 140 to said drive axle 40.

According to an aspect of the present disclosure, said transmission device 200 comprises a transmission housing 210 for housing parts associated with said transmission device 200.

Said transmission device 200 of said drive arrangement D comprises a torque arm 220, see e.g. FIG. 5. Said torque arm 220 is configured to provide torque resistance in connection to rotation of said drive axle 40. Said torque arm 220 is configured to be connected to said track support beam 10 so as to essentially prevent rotation of said transmission device 200 about said centre axis Z.

According to an aspect of the present disclosure, said transmission device 200 comprises a gear arrangement 260. Said gear arrangement 260 may be any suitable gear arrangement for transferring torque from the motor device 100 to said drive wheel member DW for driving a track assembly and hence driving the tracked vehicle having said track assembly.

According to an aspect of the present disclosure, said gear arrangement 260 may comprise a planetary gear configuration. The transmission device 200 comprises a bearing configuration B260 arranged for providing bearing of said gear arrangement 260. According to an aspect of the present disclosure, said bearing configuration B260 is a needle roller bearing device.

Said transmission device 200 is configured to transfer said torque from said motor device 100 to said drive wheel member DW via said drive axle 40 by means of said gear arrangement 260.

According to an aspect of the present disclosure, said drive axle 40 is configured to run from said transmission device through the inner drive wheel DW2, through the through hole H of said track support beam 10 in connection to said bearing configuration 20, through said outer drive wheel DW1 and further through a major portion of said brake arrangement 300.

According to an aspect of the present disclosure, said motor device 100 and transmission device 200 are comprised in a drive unit M. Said drive arrangement D thus comprises a drive unit M comprising said motor device 100 and transmission device 200. Said motor device 100 and transmission device 200 of the drive arrangement D thus provides a drive unit M. The drive unit M comprises a housing configuration 110, 210. Said housing configuration 110, 210 comprises said motor housing 110 and said transmission housing 210.

According to an aspect of the present disclosure, said drive unit M is configured to be pivotably journaled in bearings in connection to a portion of the drive axle 40 configured to protrude from the inner side 10b of said track support beam 10 so as to allow rotation of the drive axle 40 relative to said housing configuration 110, 210 of said drive unit M. The bearing configuration B200 is configured to be arranged around said portion of said drive axle 40 configured to protrude from the inner side 10b of said track support beam 10.

According to an aspect of the present disclosure, the drive arrangement D comprises a bearing configuration B200 arranged in said housing configuration of said drive unit M, here in connection to the transmission housing 210, for providing bearing of said drive unit M. According to an aspect of the present disclosure, said bearing configuration B200 is a tapered roller bearing device.

According to an aspect of the present disclosure, the drive axle 40 is configured to be connected to the bearing configuration B200 by means of a splines connection so that said drive axle 40 may be rotated relative to said housing configuration, i.e. said transmission housing 210.

According to an aspect of the present disclosure, the drive arrangement D comprises a centre support bar 30 coaxially arranged within said drive arrangement D. Said centre support bar 30 is configured to run in the axial direction, i.e. in the direction of said axis Z. Said centre support bar 30 is configured to run transversely relative to the longitudinal extension of said track support beam 10.

Said centre support bar 30 is configured to supportingly connect said transmission device 200 and brake arrangement 300. Said centre support bar 30 is configured to supportingly connect said drive unit M and brake arrangement 300.

Said centre support bar 30 is configured to coaxially coincide with the centre axis Z of said drive wheel member DW.

Said centre support bar 30 is configured to run through said drive axle 40 so as to provide said connection of said transmission device 200 and brake arrangement 300. Said centre support bar 30 is configured to run through said drive axle 40 so as to provide said connection of said drive unit M and brake arrangement 300.

Said drive axle 40 thus has a tube configuration. Said drive axle 40 thus has the shape of a tube, providing a through hole for said centre support bar 30. Said drive axle 40 thus has a tube configuration, configured to receive said centre support bar 30. Said drive axle 40 has a hollow configuration for allowing introduction of said centre support bar 30 into said drive axle 40.

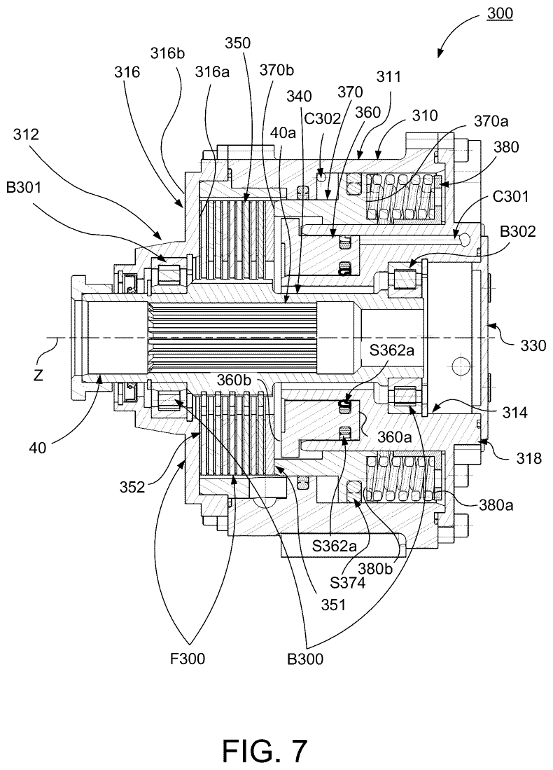

FIG. 7 schematically illustrates a cross sectional view of a brake arrangement 300 according to an aspect of the present disclosure.

The brake arrangement 300 is according to an aspect of the present disclosure configured to be comprised in a drive arrangement D according to the present disclosure, e.g. as described with reference to FIG. 5 and FIG. 6, which in turn is configured to be comprised in a track assembly of a tracked vehicle, see e.g. FIGS. 1A-1B, FIG. 2 and FIGS. 3A-3B.

Said brake arrangement 300 comprises a brake housing 310 for brake parts associated with said brake device 300. The brake arrangement 300 comprises said brake housing 310 configured to provide an enclosure for brake units of said brake arrangement 300. Said brake arrangement 300 is configured to be journaled in bearings in connection to a drive member driven drive axle 40 so as to allow rotation of said drive axle 40 relative to said brake housing 310. Said brake housing 310 is configured to be journaled in bearings in connection to a drive member driven drive axle 40 so as to allow rotation of said drive axle 40 relative to said brake housing 310. Said drive axle 40 is configured to rotate a drive wheel member DW for a track assembly of a tracked vehicle.

According to an aspect of the present disclosure, said brake housing 310 has a ring shaped configuration. According to an aspect of the present disclosure, said brake housing 310 has an outer wall portion 311 configured to surround said drive axle 40, when said brake arrangement is arranged in connection to said drive axle 40. According to an aspect of the present disclosure, said outer wall portion 311 is configured to be essentially coaxially arranged relative to said centre axis Z. According to an aspect of the present disclosure, said outer wall portion 311 is configured to be essentially coaxially arranged relative to said drive axle 40, when said brake arrangement is arranged in connection to said drive axle 40.

According to an aspect of the present disclosure, said brake housing 310 has a first support portion 312. According to an aspect of the present disclosure, said first support portion 312 is configured to be associated with said journaling in bearings of said brake housing 310. According to an aspect of the present disclosure, said first support portion 312 is configured to be arranged in connection to said drive wheel member DW when said brake arrangement 300 is comprised in said drive arrangement D, being suspendedly arranged in connection to said track support beam 10 of a track assembly.

According to an aspect of the present disclosure, said first support portion 312 is configured to face the track support beam 10, when said brake arrangement 300 is comprised in said drive arrangement D. According to an aspect of the present disclosure, said first support portion 312 is configured to face the outer side 10a of said track support beam 10, when said brake arrangement 300 is comprised in said drive arrangement D.

According to an aspect of the present disclosure, said first support portion 312 is configured to be arranged in connection to said first drive wheel DW1 of said drive wheel member DW of said track assembly. According to an aspect of the present disclosure, said first support portion 312 is configured to be arranged about said drive axle 40. According to an aspect of the present disclosure, said first support portion 312 has a ring shaped configuration.

According to an aspect of the present disclosure, said brake housing 310 has a second support portion 314. According to an aspect of the present disclosure, said second support portion 314 is configured to be associated with said journaling in bearings of said brake housing 310.

According to an aspect of the present disclosure, said second support portion 314 is configured to be arranged axially opposite to said first support portion 312, and thus away from said drive wheel member DW when said brake arrangement 300 is comprised in said drive arrangement D, being suspendedly arranged in connection to said track support beam 10 of a track assembly.

According to an aspect of the present disclosure, said second support portion 314 is configured to face away from said track support beam 10, when said brake arrangement 300 is comprised in said drive arrangement D. According to an aspect of the present disclosure, said second support portion 314 is configured to be arranged in connection to an outer side of said brake housing 310, facing away from said drive wheel member DW and track support beam 10, when said brake arrangement 300 is comprised in said drive arrangement D, and thus being journaled in bearings in said track support beam.

According to an aspect of the present disclosure, said second support portion 314 is configured to be arranged about said drive axle 40. According to an aspect of the present disclosure, said second support portion 314 has a ring shaped configuration.

According to an aspect of the present disclosure, said brake housing 310 has a first end portion 316 configured to face said track support beam 10 when said brake arrangement 300 is comprised in said drive arrangement D.

According to an aspect of the present disclosure, said first end portion 316 is configured to face the outer side 10a of said track support beam 10, when said brake arrangement 300 is comprised in said drive arrangement D.

According to an aspect of the present disclosure, said first end portion 316 is arranged in connection to said first support portion 312. According to an aspect of the present disclosure, said first end portion 316 has a wall shape configured to extend in a plane essentially perpendicular to the extension of said centre axis Z.

According to an aspect of the present disclosure, said first end portion 316 has a wall shape configured to surround said drive axle 40. According to an aspect of the present disclosure, said first end portion 316 may be denoted first end wall portion 316. According to an aspect of the present disclosure, said first end portion 316 is configured to be connected to or transfer into said outer wall portion 311 in connection to a radially outer end of said first end portion 316.

According to an aspect of the present disclosure, said brake housing 310 has a second end portion 318 configured to face away from said track support beam 10 when said brake arrangement 300 is comprised in said drive arrangement D. Said second end portion 318 is essentially opposite to said first end portion 316. According to an aspect of the present disclosure, said second end portion 316 is configured to face away from the outer side 10a of said track support beam 10, when said brake arrangement 300 is comprised in said drive arrangement D. According to an aspect of the present disclosure, said second end portion 318 is arranged in connection to said second support portion 314. According to an aspect of the present disclosure, said second end portion 318 has a wall shape configured to extend in a plane essentially perpendicular to the extension of said centre axis Z. According to an aspect of the present disclosure, said second end portion 318 is configured to be connected to or transfer into said outer wall portion 311 in connection to a radially outer end of said second end portion 318.

Said brake arrangement 300 further comprises a hollow brake axle 340. Said hollow brake axle 340 is coaxially arranged relative to said centre axis Z. Said hollow brake axle 340 is configured to be arranged around said drive axle 40 so that the brake axle 340 is rotated by means of said drive axle 40. Said hollow brake axle 340 is according to an aspect of the present disclosure configured to be connected to said drive axle 40 by means of a splines connection around said drive axle so that the brake axle 340 is rotated by rotation of said drive axle 40.

According to an aspect of the present disclosure, said outer wall portion 311 is configured to surround said brake axle 40. According to an aspect of the present disclosure, said outer wall portion 311 is configured to be essentially coaxially arranged relative to said brake axle 340. According to an aspect of the present disclosure, said first end portion 316 has a wall shape configured to surround said brake axle 340 and extending in a plane essentially perpendicular to the axial extension of said brake axle 340.

According to an aspect of the present disclosure, said brake housing 310 is configured to be journaled in bearings to said brake axle 340 such that said journaling in bearings in connection to said drive axle 40 is provided when said brake arrangement 300 is connected to said drive axle 40. According to an aspect of the present disclosure, said brake arrangement 300 is configured to be journaled in bearings in connection to an outer portion 40a of the drive axle 40 protruding in the axial direction from the outer side 10a of said track support beam 10 when said brake arrangement 300 is connected to said drive axle 40 and hence drive arrangement D of a track assembly. Said brake housing 310 is configured to be journaled in bearings to said brake axle 340 such that said journaling in bearings in connection to said outer portion 40a of the drive axle 40 is provided when said brake arrangement 300 is connected to said drive axle 40.

According to an aspect of the present disclosure, said first support portion 312 is configured to be arranged about said brake axle 340. According to an aspect of the present disclosure, said second support portion 314 is configured to be arranged about said brake axle 340.

Said brake device 300 comprises a bearing configuration B300 for providing said journaling in bearings of said brake housing 310 in connection to said brake axle 340. Said bearing configuration B300 is arranged in said brake housing 310 of said brake arrangement 300.

Said bearing configuration B300 comprises a first bearing member B301 and a second bearing member B302 arranged at an axial distance from said first bearing member B301. One of said first bearing member B301 and second bearing member B302 is provided with a flange configuration for holding the brake housing 310 in the axial direction and the other of said first bearing member B301 and second bearing member B302 is configured to allow certain axial movement of said housing 310 relative to said brake axle 340.

In the exemplary embodiment schematically illustrated in FIG. 7, the first bearing member B301 is configured to allow certain axial movement of said housing 310 relative to said brake axle 340. In the exemplary embodiment schematically illustrated in FIG. 7, the second bearing member B302 is provided with a flange configuration for holding the brake housing 310 in the axial direction.

According to an aspect of the present disclosure, said first bearing member B301 is arranged in connection to said first support portion 312 of said brake housing 310. According to an aspect of the present disclosure, said first bearing member B301 is arranged around said brake axle 340, between said brake axle 340 and said first support portion 312, and in connection to said brake axle 340 and said first support portions 312 so as to allow rotation of said brake axle 340 relative to said first support portion 312 and hence relative to said brake housing 310. According to an aspect of the present disclosure said first bearing member B301 is a cylindrical roller bearing member.

According to an aspect of the present disclosure, said second bearing member B302 is arranged in connection to said second support portion 314 of said brake housing 310, axially opposite to said first support portion 312. According to an aspect of the present disclosure, said second bearing member B302 is arranged around said brake axle 340, between said brake axle 340 and said second support portion 314, and in connection to said brake axle 340 and said second support portions 314 so as to allow rotation of said brake axle 340 relative to said second support portion 314 and hence relative to said brake housing 310. According to an aspect of the present disclosure said second bearing member B302 is a cylindrical roller bearing member.

Said brake arrangement 300 comprises a set of friction elements 350, illustrated in FIG. 7 arranged within said brake housing 310.

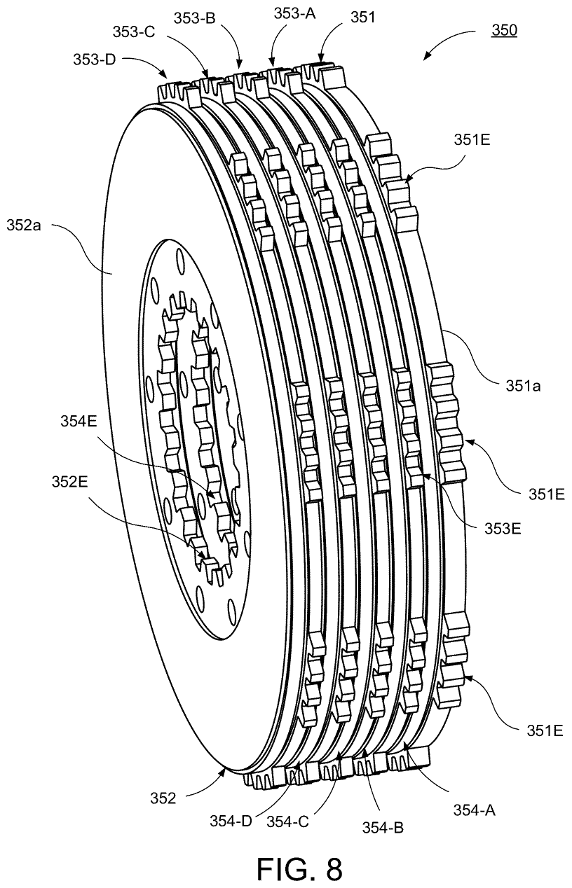

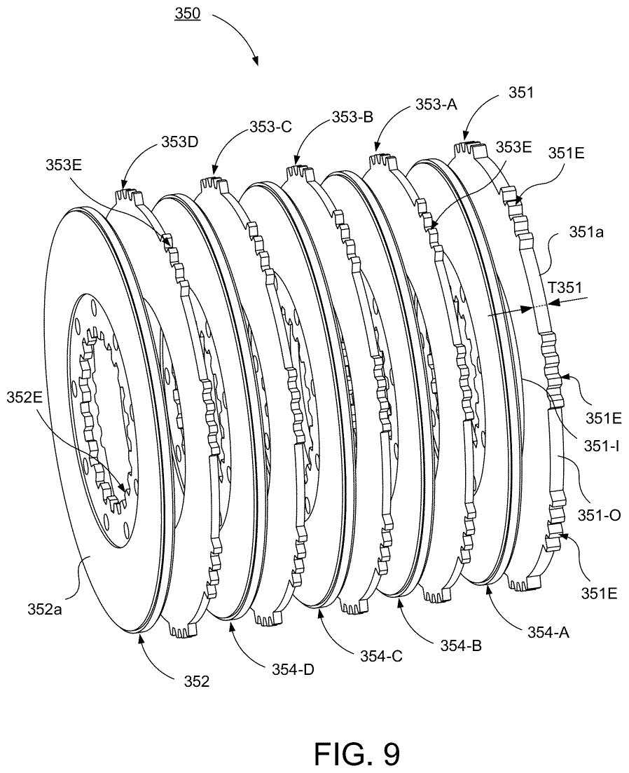

FIG. 8 schematically illustrates a perspective view of said set of friction elements 350 in a compressed state according to an aspect of the present disclosure. FIG. 9 schematically illustrates an exploded perspective view of said set of friction elements 350 according to an aspect of the present disclosure.

Said set of friction elements 350 according to the present disclosure may also be denoted brake friction device 350 or brake friction package 350.

Said set of friction elements 350 are configured to be arranged about said drive axle 40. Said set of friction elements 350 are configured to be arranged about said hollow brake axle 340, being arranged about said drive axle 40. According to an aspect of the present disclosure, said set of friction elements 350 are configured to be concentrically arranged about said brake axle 340. Said set of friction elements 350 are configured to be axially arranged in relation to each other.

According to an aspect of the present disclosure, said set of friction elements 350 have a ring-shaped configuration.

According to an aspect of the present disclosure, said set of friction elements 350 are configured to extend in a plane essentially perpendicular to the axial extension of said brake axle 340.

According to an aspect of the present disclosure, said set of friction elements 350 are arranged to be assembled together along and in connection to said brake axle 340 so that friction elements of said set of friction elements are allowed to be pressed against adjacent friction elements so as to obtain friction for providing a braking function.

Said set of friction elements 350 are configured to be pressed together in the axial direction for providing a braking function in connection to said drive axle 40. Said set of friction elements 350 are configured to be pressed together in the axial direction for increasing the friction between adjacent friction elements of said set of friction elements for providing said braking function.

Said set of friction elements 350 comprises a first end friction element 351 being the axially outermost friction element against which pressure is configured to be provided for said braking function. Said set of friction elements 350 comprises a second end friction element 352 being arranged farthest away from said first end element 351. Said set of friction elements 350 comprises a set of intermediate friction elements 353-A, 353-B, 353-C, 353-D, 354-A, 354-B, 354-C, 354-D arranged between said first end friction element 351 and second end friction element 352.

Said set of friction elements 350 are configured to be arranged about said drive axle 40 axially in relation to each other. Said first end friction element 351 is the axially outermost friction element at the end from which pressure is configured to be provided.

According to an aspect of the present disclosure, said set of friction elements 350 are arranged in connection to said first end wall portion 316. Said first end wall portion 316 has an inner side 316a and an opposite outer side 316b. Said inner side 316a is configured to face towards said opposite end portion 318 of said brake housing 310. Said inner side 316a is configured to face away from said outer side 10a of said track support beam 10.

According to an aspect of the present disclosure, said set of friction elements 350 are arranged in connection to said end wall portion 316 such that said end wall portion 316 and set of friction elements 350 provides a friction arrangement F300 for providing said braking. Said brake arrangement 300 thus comprises a friction arrangement F300 comprising said set of friction elements 350 and said end wall portion 316.

According to an aspect of the present disclosure, said second end friction element 352 is configured to be arranged in connection to said inner side 316a of said first end wall portion 316.

According to an aspect of the present disclosure, said second end friction element 352 is configured to be arranged in connection to said inner side 316a of said first end wall portion 316, such that when said set of friction elements 350 are pressed together in the axial direction for providing a braking function, said second end element 352 is pressed against said inner side 316a of said end wall portion 316.

According to an aspect of the present disclosure, said second end friction element 352 has a first side 352a configured to face said inner side 316a of said end wall portion 316. Said first end friction element 351 has a first side 351a configured to face in the opposite direction as said first side 352a of said second end friction element 352.

Said ring-shaped friction elements of said set of friction elements 350 has an inner circumference and outer circumference. In FIG. 9 of said inner circumference of said first end friction element 351 is denoted 351-I and outer circumference of said first end friction element 351 is denoted 351-0.

According to an aspect of the present disclosure, said first side 351a of said first end friction element 351 is configured to receive pressure in connection to a brake action.

According to an aspect of the present disclosure, said first end friction element 351 has a thickness T351 in the axial direction which is thicker than each of the remaining set of friction elements 350 so as to facilitate distributing an even pressure on said set of friction elements 350 when said set of friction elements 350 are pressed together for efficient friction braking function.

According to an aspect of the present disclosure, said first end friction element 351 has a thickness in the axial direction which is thicker than any of the other friction elements of the set of friction elements. According to an aspect of the present disclosure, each of the other friction elements, i.e. the intermediate friction elements 353-A, 353-B, 353-C, 353-D, 354-A, 354-B, 354-C, 354-D arranged between said first end friction element 351 and the second end friction element 352, of the set of friction elements 350 has essentially the same axial thickness, which is smaller than the axial thickness of the first end friction element 351.

According to an aspect of the present disclosure, said first end friction element 351 has a thickness T351 in the axial direction which is thicker than the individual thickness in the axial direction of the respective remaining set of friction elements 350 so as to facilitate distributing an even pressure on said set of friction elements 350 when said set of friction elements 350 are pressed together for efficient friction braking function. By thus providing said first end friction element 351 with a thickness T351 in the axial direction which is thicker than the individual thickness in the axial direction of the respective remaining set of friction elements 350, said first end element will to a higher extent resist pressure such that the shape of the first end element 351 will remain essentially the same, facilitating a distributing a more even pressure on said set of friction elements 350 when said set of friction elements 350 are pressed together for efficient friction braking function.

According to an aspect of the present disclosure, said set of friction elements 350 comprises a first set of friction elements 351, 353-A, 353-B, 353-C, 353-D configured to be engaged to said brake housing 310. According to an aspect of the present disclosure, said set of friction elements 350 comprises a second set of friction elements 352, 354-A, 354-B, 354-C, 354-D configured to be attached to said to said brake axle 340 for allowing rotation of said second set of friction elements relative to said first set of friction elements.

According to an aspect of the present disclosure, said first set of friction elements 351, 353-A, 353-B, 353-C, 353-D and second set of friction elements 352, 354-A, 354-B, 354-C, 354-D are alternatingly arranged relative to each other. According to an aspect of the present disclosure, a friction element of said first set of friction elements being engaged to said brake housing 310 has a friction element of said second set of friction elements being engaged to said brake axle 340 adjacently arranged and so on.

According to an aspect of the present disclosure, said first set of friction elements 351, 353-A, 353-B, 353-C, 353-D configured to be engaged to said brake housing 310 comprises said first end friction element 351.

According to an aspect of the present disclosure, said second set of friction elements 352, 354-A, 354-B, 354-C, 354-D configured to be engaged to said brake axle 340 comprises said second end friction element 352.

According to an aspect of the present disclosure, said first set of friction elements 351, 353-A, 353-B, 353-C, 353-D configured to be engaged to said brake housing 310 are configured to be engaged so as to essentially prevent movement between said first set of friction elements 351, 353-A, 353-B, 353-C, 353-D and said brake housing in the direction of rotation about said brake axle 340.

According to an aspect of the present disclosure, said first set of friction elements 351, 353-A, 353-B, 353-C, 353-D configured to be engaged to said brake housing 310 are configured to be engaged so as to allow certain movement between said first set of friction elements 351, 353-A, 353-B, 353-C, 353-D and said brake housing in the axial direction of said brake axle 340.

According to an aspect of the present disclosure, said first set of friction elements 351, 353-A, 353-B, 353-C, 353-D configured to be engaged to said brake housing 310 comprises outer engagement members configured to engage with inner engagement members of said brake housing 310.

According to an aspect of the present disclosure, said outer engagement members comprises sprocket members configured to project from the outer circumference of the respective friction element of said first set of friction elements 351, 353-A, 353-B, 353-C, 353-D.

According to an aspect of the present disclosure, said inner engagement members may be provided by splines. In the embodiment in FIG. 8 and FIG. 9 said sprocket members are denoted 351E for the first end friction element and 353E for the remaining friction element 353-A, 353-B, 353-C, 353-D of said first set of friction elements 351, 353-A, 353-B, 353-C, 353-D.

According to an aspect of the present disclosure, said second set of friction elements 352, 354-A, 354-B, 354-C, 354-D configured to be engaged to said brake axle 340 are configured to be engaged so as to essentially prevent movement between said second set of friction elements 352, 354-A, 354-B, 354-C, 354-D and said brake axle in the direction of rotation about said brake axle 340, i.e. said second set of friction elements are configured to rotate with said brake axel 340.

According to an aspect of the present disclosure, said second set of friction elements 352, 354-A, 354-B, 354-C, 354-D configured to be engaged to said brake axle 340 are configured to be engaged so as to allow certain movement of said second set of friction elements 351, 353-A, 353-B, 353-C, 353-D relative to said brake axle 340 in the axial direction of said brake axle 340.

According to an aspect of the present disclosure, said second set of friction elements 352, 354-A, 354-B, 354-C, 354-D configured to be engaged to said brake axle 340 comprises inner engagement members configured to engage with outer engagement members of said brake axle 340.

According to an aspect of the present disclosure, said inner engagement members comprises sprocket members configured to project from the inner circumference of the respective ring-shaped friction element of said second set of friction elements 352, 354-A, 354-B, 354-C, 354-D.

According to an aspect of the present disclosure, said outer engagement members may be provided by splines. In the embodiment in FIG. 8 and FIG. 9 said sprocket members are denoted 352E for the second end friction element and 354E for the remaining friction element 354-A, 354-B, 354-C, 354-D of said second set of friction elements 352, 354-A, 354-B, 354-C, 354-D.

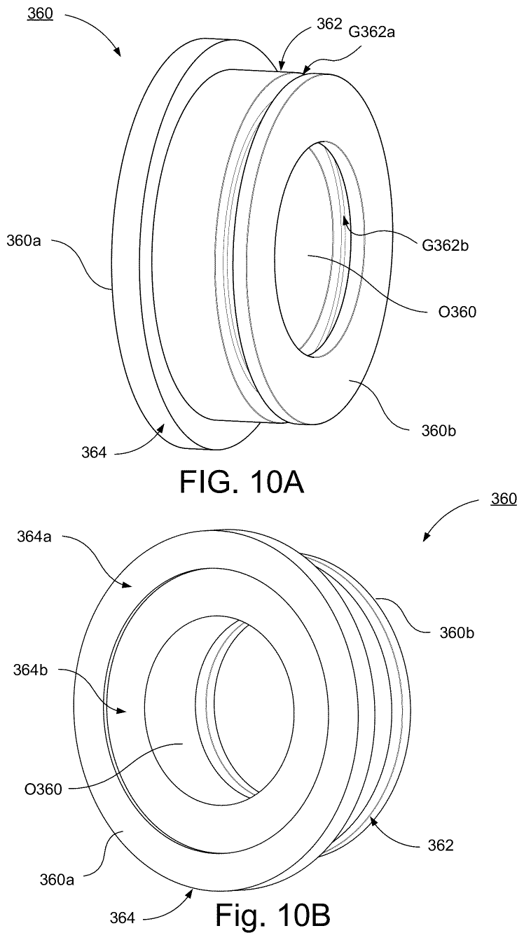

FIGS. 10A-10B schematically illustrates a perspective views of a service brake piston device 360 of the brake arrangement in FIG. 7 according to an aspect of the present disclosure. Said brake piston device 360 is also schematically illustrated in FIG. 7.

According to an aspect of the present disclosure, said brake arrangement 300 further comprises a service brake piston device 360 arranged in connection to said set of friction elements 350.

According to an aspect of the present disclosure, said service brake piston device 360 is ring-shaped. According to an aspect of the present disclosure, said service brake piston device 360 has a through opening O360 running through said service brake piston device 360. According to an aspect of the present disclosure, said service brake piston device 360 is configured to be coaxially arranged around said brake axle 340.

According to an aspect of the present disclosure, said service brake piston device 360 has an outer side 360a configured to face away from said set of friction elements 350 and an opposite inner side 360b configured to face towards said set of friction elements 350.

Said inner side 360b of said service brake piston device 360 is configured to be arranged adjacent to said first end friction element 351. Said inner side 360b of said service brake piston device 360 is configured to face said first side 351a of said first end friction element 351.

According to an aspect of the present disclosure, said inner side 360b of said service brake piston device 360 is configured to face a central portion of said first side 351a of said first end friction element 351. According to an aspect of the present disclosure, said inner side 360b of said service brake piston device 360 is configured to face a central portion of said first side 351a of said first end friction element 351 arranged radially between the inner circumference 351-I and outer circumference 351-O of said first end friction element 351.

According to an aspect of the present disclosure, said outer side 360a of said service brake piston device 360 is configured to face out from the side of a track assembly of a tracked vehicle when said brake arrangement 300 is assembled to a tracked vehicle, wherein said inner side 360b of said service brake piston device 360 is configured to be arranged opposite to said outer side 360a, towards vehicle body of adjacent to said first end friction element 351.

According to an aspect of the present disclosure, said service brake piston device 360 has a ring shaped inner portion 362 and a ring shaped outer portion 364. According to an aspect of the present disclosure, said ring shaped inner portion 362 has a smaller outer diameter than the ring shaped outer portion 364. According to an aspect of the present disclosure, said ring shaped inner portion 362 has the inner side 360b facing the set of friction elements 350, and the ring shaped outer portion 364 has the outer side 360a.

According to an aspect of the present disclosure, said ring shaped inner portion 362 has an outer groove G362a arranged circumferentially around the outer side of said ring-shaped inner portion 362. Said outer groove G362a is configured to receive an outer sealing member S362a for providing sealing towards a portion of said break housing 310 arranged externally around said inner portion 362.

According to an aspect of the present disclosure, said ring shaped inner portion 362 has an inner groove G362b arranged circumferentially around the inner side of said ring-shaped inner portion 362. Said inner groove G362b is configured to receive an inner sealing member S362b for providing sealing towards a portion of said break housing 310 arranged internally around said inner portion 362.

According to an aspect of the present disclosure, said ring shaped outer portion 364 has a circumferentially outer ring-shaped portion 364a configured to provide the contact portion for providing contact with said first end friction element 351, thus providing said outer side 360a. According to an aspect of the present disclosure, said ring shaped outer portion 364 has a circumferentially inner ring-shaped portion 364b arranged circumferentially inside of said circumferentially outer ring-shaped portion 364a. Said circumferentially outer ring-shaped portion 364a has an axial extension, extending further than the circumferentially inner ring-shaped portion 364b, such that the circumferentially outer ring-shaped portion 364a provides the contact with said first end friction element 351 in connection to a brake operation.

According to an aspect of the present disclosure, said service brake piston device 360 is configured to act on said set of friction elements 350 based on a brake action so as to press said set of friction elements 350 together for providing a braking function for braking rotation of said drive axle 40 so as to brake drive wheel member DW for stopping drive of a tracked vehicle provided with said brake arrangement 300. According to an aspect of the present disclosure, said service brake piston device 360 is configured to act directly on said set of friction elements 350. According to an aspect of the present disclosure, said service brake piston device 360 is configured to act directly on said central portion of said first side 351a of said first end friction element 351.

During drive of said drive axle 40, said drive axle is rotating, wherein said hollow brake axle 340, which is engaged, e.g. by means of a splines connection, around said drive axle 40, is rotating. Hereby said second set of friction elements 352, 354-A, 354-B, 354-C, 354-D of said set of friction elements 350, which second set of friction elements 352, 354-A, 354-B, 354-C, 354-D are engaged to said brake axle 340 are rotated relative to said first set of friction elements 353-A, 353-B, 353-C, 353-D of said set of friction elements 350, which first set of elements are engaged to said brake housing 310.

When said service brake piston device 360 acts on said set of friction elements 350 based on a brake action, the rotating second set of elements 352, 354-A, 354-B, 354-C, 354-D and non-rotating first set of elements 353-A, 353-B, 353-C, 353-D are pressed together so that a friction between said elements is provided so that said brake function is provided.

According to an aspect of the present disclosure, said brake arrangement 300 further comprises a channel configuration within said brake housing 310. According to an aspect of the present disclosure, said channel configuration comprises at least one channel C301 in connection to said service brake piston device 360, see e.g. FIG. 7. According to an aspect of the present disclosure, said service brake piston device 360 is configured to receive, in connection to a braking action, pressurized fluid via said at least one channel C301 such that said service brake piston device 360 acts on said set of friction elements 350.

According to an aspect of the present disclosure, said at least one channel C301 may be connected to a hydraulic system of the tracked vehicle, wherein said hydraulic system is configured to provide pressurized fluid to said at least one channel C301 for providing said pressurized fluid for said brake action.

According to an aspect of the present disclosure, said channel configuration with said at least one channel C301 in connection to said service brake piston device 360 may be comprised in a fluid system for transporting fluid for said brake arrangement 300. According to an aspect of the present disclosure, said fluid system comprises a pump arrangement comprising one or more pump units arranged for transporting fluid to and/or from said brake arrangement 300.

According to an aspect of the present disclosure, said brake arrangement 300 comprises a torque arm 320 configured to be connected to said track support beam 10 so as to essentially prevent rotation of said brake arrangement 300 about said centre axis Z.

According to an aspect of the present disclosure, said torque arm 320 is attached to or constitutes a portion of said housing 310. According to an aspect of the present disclosure, said torque arm 320 is configured to provide transport through said torque arm 320 to parts of the brake arrangement in need of fluid and/or from one or more spaces within the brake arrangement. According to an aspect of the present disclosure, said torque arm 320 is configured to provide transport through said torque arm 320 to said at least one channel C301 in connection to said service brake piston device 360.

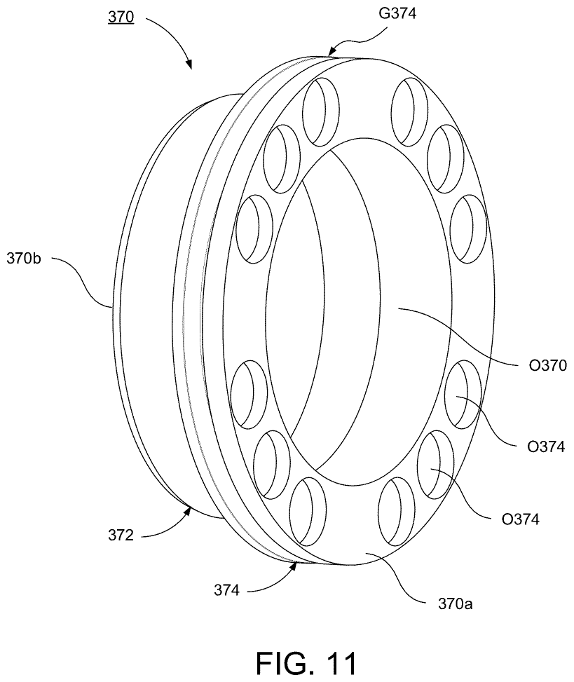

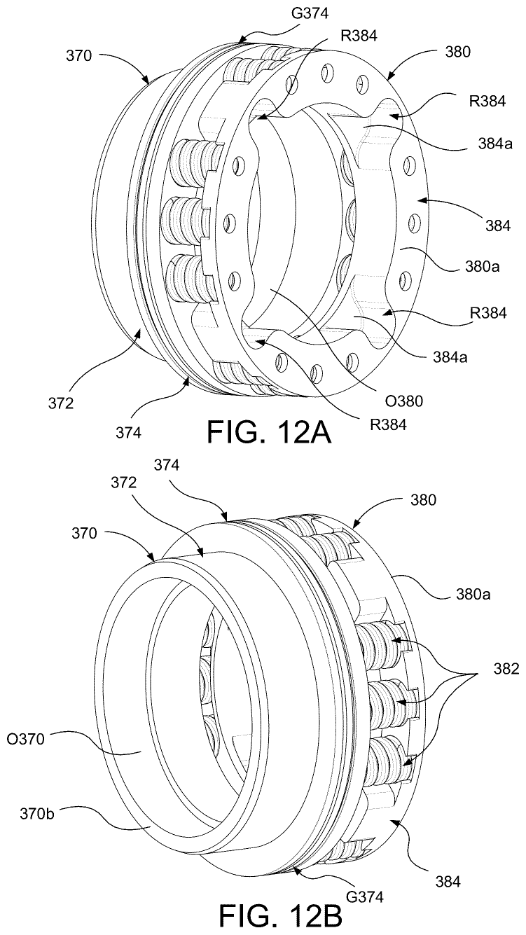

FIG. 11 schematically illustrates a perspective view of a parking brake piston device 370 of the brake arrangement in FIG. 7 according to an aspect of the present disclosure. FIGS. 12A-12B schematically illustrate perspective view of a spring device 380 of the brake arrangement in FIG. 7 arranged in connection to the parking brake piston device 370 in FIG. 11, according to an aspect of the present disclosure.

According to an aspect of the present disclosure, said brake arrangement 300 further comprises a parking brake piston device 370 arranged in connection to said set of friction elements 350.

According to an aspect of the present disclosure, said parking brake piston device 370 is ring shaped and configured to be coaxially arranged around said brake axle 340. According to an aspect of the present disclosure, said ring shaped parking brake piston device 370 has a central opening O370 running through said parking brake piston device 370.

According to an aspect of the present disclosure, said parking brake piston device 370 is configured to be arranged in connection to said service brake piston device 360.

According to an aspect of the present disclosure, said parking brake piston device 370 is configured to be arranged in connection to said service brake piston device 360 so as to facilitate independent operation of the service brake piston device 360 and parking brake piston device 370. According to an aspect of the present disclosure, said service brake piston device 360 and parking brake piston device 370 are configured to be arranged relative to each other so that both the service brake piston device 360 and the parking brake piston device 370 may act directly against said axially outermost first end friction element 351 so as to facilitate independent operation of the service brake piston device 360 and parking brake piston device 370.

According to an aspect of the present disclosure, said parking brake piston device 370 is configured to be arranged at least partly around said service brake piston device 360. According to an aspect of the present disclosure, said parking brake piston device 370 is configured to be arranged radially externally relative to said service brake piston device 360.

Thus, according to an aspect of the present disclosure, said ring shaped service brake piston device 360 is configured to be coaxially arranged around said drive axle 40 radially internally relative to said parking brake piston device 370, wherein said parking brake piston device 370 is configured to be coaxially arranged around said drive axle 40 in connection to a radially outer portion of said set of friction elements 350 at least partly around said service brake device 360 so that said parking brake piston device 370 is configured to provide pressure in the axial direction directly against said radially outer portion of said set of friction elements 350.

According to an aspect of the present disclosure, said parking brake piston device 370 has an outer side 370a configured to face away from said set of friction elements and an opposite inner side 370b configured to face towards said set of friction elements 350. Said inner side 370b of said parking brake piston device 370 is configured to be arranged adjacent to said first end friction element 351.

Said inner side 370b of said parking brake piston device 370 is configured to face said first side 351a of said first end friction element 351. According to an aspect of the present disclosure, said inner side 370b of said parking brake piston device 370 is configured to face a radially outer portion of said first side 351a of said first end friction element 351.

According to an aspect of the present disclosure, said parking brake piston device 370 has a ring shaped inner portion 372 and a ring shaped outer portion 374. According to an aspect of the present disclosure, said ring shaped inner portion 372 has a smaller outer diameter than the ring shaped outer portion 374. According to an aspect of the present disclosure, said ring shaped inner portion 372 has the inner side 370b facing the set of friction elements 350, and the ring shaped outer portion 374 has the outer side 370a.

According to an aspect of the present disclosure, said ring shaped outer portion 374 has an outer groove G374a arranged circumferentially around the outer side of said ring-shaped outer portion 374. Said outer groove G374a is configured to receive an outer sealing member S374 for providing sealing towards a portion of said break housing 310 arranged externally around said outer portion 374.

According to an aspect of the present disclosure, said parking brake piston device 370 is configured to provide pressure in the axial direction against a radially outer portion of said set of friction elements 350.

According to an aspect of the present disclosure, said parking brake piston device 370 is configured to act on said set of friction elements 350 based on a parking brake action indicating parking of a vehicle for pressing said elements together for providing a parking brake function for preventing rotation of said drive axle 40 so as to provide a parking brake activated state, preventing movement of drive wheel member DW for keeping a vehicle provided with said brake arrangement 300 in a parked position.

According to an aspect of the present disclosure, said brake arrangement 300 further comprises a spring device 380 arranged in connection to said parking brake piston device 370, see e.g. FIGS. 12A-12B.

According to an aspect of the present disclosure, said spring device 380 has a ring shaped configuration. According to an aspect of the present disclosure, said spring device 380 is configured to be coaxially arranged around said brake axle 340.

According to an aspect of the present disclosure, said spring device 380 comprises a set of spring members 382 configured to be distributed around said brake axle 340 in connection to said ring shaped parking brake piston device 370, see e.g. FIGS. 12A-12B. According to an aspect of the present disclosure, said parking brake piston device 370 has, on its outer side 370a, a set of openings O374, see FIG. 11, for receiving said spring members 382. According to an aspect of the present disclosure, said set of openings O374 are configured to be distributed on the outer portion 374 of said parking brake piston device 370.

According to an aspect of the present disclosure, said spring device 380 comprises a ring-shaped support member 384 for supporting said spring members 382. According to an aspect of the present disclosure, said spring members 382 are distributed around and assembled to said ring-shaped support member 384, see e.g. FIGS. 12A-12B.

According to an aspect of the present disclosure, said spring device 380 has an outer side 380a configured to face away from said parking brake piston device 370 and an opposite inner side 380b configured to face towards said parking brake piston device 370. Said inner side 380b of said spring device 380 is configured to be arranged adjacent to said outer side 370a of said parking brake piston device 370.

Said ring-shaped support member 384 has a set of recesses distributed around the circumference, said recesses running in the axial direction, from the outer side 380a to a stop portion 384a or stop side 384a of a floor portion provided by said recesses R384.

According to an aspect of the present disclosure, said spring device 380, in a non-parking brake activated state, is configured to be compressed by means of providing a hydraulic pressure on said spring device 380 so that said parking brake piston device 370 does not act on said set of friction elements.

According to an aspect of the present disclosure, in connection to a parking brake action, said hydraulic pressure on said spring device 380 is configured to be removed such that said spring device 380 acts on said parking brake piston device 370 by means of a spring force so as to provide a parking brake activated state.

According to an aspect of the present disclosure, said parking brake piston device 370 is configured to receive, in connection to a non-parking brake activated state, pressurized fluid via at least one channel of said channel configuration, such that said parking brake piston device 370 acts on said spring device 380 for providing said compressed state of said spring device.

Said parking brake piston device 370 is configured to, in the non-parking brake activated state, be subjected to a pressure so that it acts against said spring device 380 with a pressure exceeding the spring resistance of said spring device 380 so that said spring device is compressed.

Said parking brake piston device 370 is configured to, in a parking brake activated state, be subjected to a spring pressure by means of said spring device 380 so that said parking brake piston device 370 acts on said set of friction elements 350 for said parking brake state.

According to an aspect of the present disclosure, said parking brake piston device 370 is thus arranged between said set of friction elements 350 and said spring device 380 for facilitating said non-parking brake activated state when subjected to said hydraulic pressure and said parking brake state when said hydraulic pressure is removed.

According to an aspect of the present disclosure, said parking brake piston device 370 is thus movably arranged between said set of friction elements 350 and said spring device 380, wherein said parking brake piston device 370 is arranged to be moved towards and against said spring device 380 for facilitating said non-parking brake activated state when subjected to said hydraulic pressure and arranged to be moved towards and against said set of friction elements 350 by means of said spring device 380 for facilitating said parking brake state, when said hydraulic pressure is removed.

According to an aspect of the present disclosure, in connection to an unexpected loss of hydraulic pressure associated with brake operation of said brake arrangement 300, said hydraulic pressure on said spring device 380 is configured to be removed such that said spring device 380 acts on said parking brake piston device 370 by means of a spring force so as to provide a parking brake activated state.

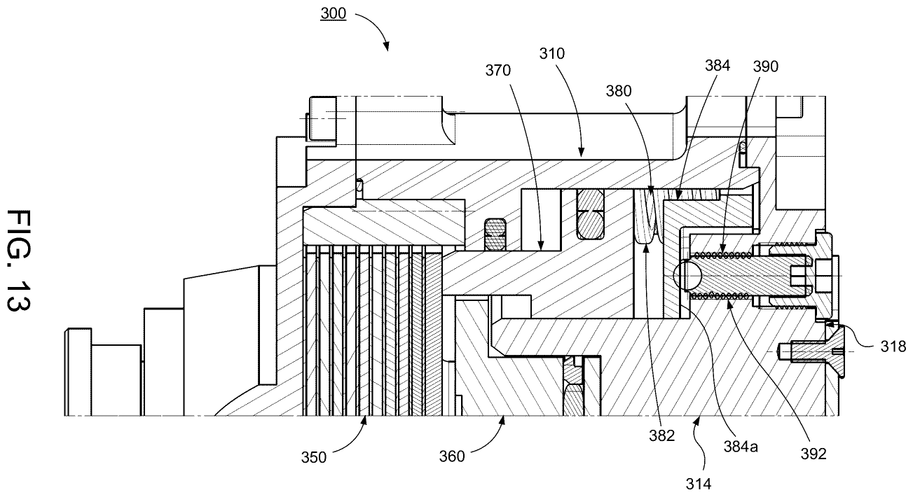

FIG. 13 schematically illustrates a cross sectional view of a portion of the brake arrangement in FIG. 7, with an adjustment device 390 of according to an aspect of the present disclosure.

According to an aspect of the present disclosure, said brake arrangement 300 further comprises an adjustment device 390 arranged in connection to said spring device 380 axially opposite to said parking brake piston device 370, said adjustment device 390 being configured to facilitate axial adjustment of said spring device 380 based on the axial position of said parking brake piston device 370.

According to an aspect of the present disclosure, said adjustment device 390 comprises a set of adjustment screw joint members 392 arranged in connection to said ring-shaped support member 384 and operable so as to provide a force against said ring-shaped support member 384 such that said ring-shaped support member 384 acts on said spring members 382 of said spring device 380 in the axial direction towards said parking brake piston device 370. Said force may by means of said screw joint members 392 may be provided by screwing said screw joint members 392.

According to an aspect of the present disclosure said set of screw joint members 392 are configured to be arranged such that each screw joint member 392 is arranged in connection to a recess R384 of said set of recesses R384 distributed around the circumference of said support member 384 such that an end portion of a screw joint member is connectable to said stop portion 384a or stop side 384a of said floor portion provided by said recesses R384 of said spring device 380. According to an aspect of the present disclosure said set of screw joint members 392 are configured to be arranged such that each screw joint member 392 is connected to a portion of said brake housing 310 and into a recess R384. According to an aspect of the present disclosure said set of screw joint members 392 are configured to be arranged such that each screw joint member 392 is connected to said second end portion 318 and/or said second support portion 314 of said brake housing 310 and into a recess R384.

According to an aspect of the present disclosure, said brake arrangement 300 further comprises an opening running from a portion of said housing 310 to said parking brake piston device 370 and configured to receive a measure pin so as to determine position of said parking brake piston device 370 relative to said portion of said housing 310 so as to determine whether there is a need for axial adjustment of said spring device 380. According to an aspect of the present disclosure, said opening is configured to run from the outer side of the brake arrangement 300, i.e. from the gable side, in connection to the second end portion 318, through a spring member 382 to said parking brake piston device 370.

According to an aspect of the present disclosure, the brake arrangement 300 comprises a closure element 330 for closing a central opening O of said second end portion 318. Said closure element 330 is operable between an open position for facilitating access inside said brake housing 310 for assembly and disassembly of said brake arrangement, and a closed position in which an enclosure of said brake arrangement 300 is provided. According to an aspect of the present disclosure, said opening is configured to run in connection to said opening O.

The foregoing description of the preferred embodiments of the invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated.

Below some aspects of the brake arrangement for a tracked vehicle according to the present disclosure are listed.

Aspect 1A. A brake arrangement 300 for a tracked vehicle V, wherein the brake arrangement 300 comprises a brake housing 310, said brake arrangement 300 being configured to be journaled in bearings in connection to a drive unit driven drive axle 40 so as to allow rotation of said drive axle 40 relative to said brake housing 310, said drive axle 40 being configured to rotate a drive wheel member DW for a track assembly of a tracked vehicle, said brake arrangement 300 comprising a set of friction elements 350 configured to be arranged about said drive axle 40, said set of friction elements 350 being configured to be pressed together in the axial direction for providing a braking function in connection to said drive axle 40, said brake arrangement 300 further comprising a hollow brake axle 340 configured to be arranged around said drive axle 40 so that the brake axle 340 is rotated by means of said drive axle 40, said brake arrangement 300 further comprising a service brake piston device 360 arranged in connection to said set of friction elements 350 and a parking brake piston device 370 arranged in connection to said set of friction elements 350, wherein said service brake piston device 360 is configured to act directly on said set of friction elements 350 based on a service brake action so as to provide a braking function for stopping drive of a vehicle provided with said brake arrangement, and wherein said parking brake piston device 370 is configured to act directly on said set of friction elements 350 based on a parking brake action indicating parking of a vehicle so as to provide a parking brake activated state, for keeping a vehicle provided with said brake arrangement in a parked position.
Aspect 2A. The brake arrangement according to aspect 1A, wherein said service brake piston device 360, in connection to a service brake action, is configured to act on said set of friction elements 350 so as to press said elements together for providing a braking function for braking rotation of said drive axle 40 so as to brake drive wheel member for stopping drive of a vehicle provided with said brake arrangement.
Aspect 3A. The brake arrangement according to aspect 1A or 2A, wherein said parking brake piston device 370, in connection to a parking brake action, is configured to act on said set of friction elements 350 so as to press said elements together for providing a parking brake function for preventing rotation of said drive axle 40 so as to provide a parking brake activated state, preventing movement of wheel member for keeping a vehicle provided with said brake arrangement in a parked position.
Aspect 4A. The brake arrangement according to any of aspects 1A-3A, wherein said brake housing 310 is configured to be journaled in bearings to said brake axle 340 such that said journaling in bearings in connection to said drive axle 40 is provided when said brake arrangement 300 is connected to said drive axle 40.
Aspect 5A. The brake arrangement according to any of aspects 1A-4A, wherein said service brake piston device 360 is configured to receive, in connection to a service brake action, pressurized fluid such that said service brake piston device 360 acts on said set of friction elements 350.
Aspect 6A. The brake arrangement according to any of aspects 1A-5A, wherein said service brake piston device 360 is ring shaped and configured to be coaxially arranged around said brake axle 340 with an inner circumference, wherein said service brake piston device 360, in connection to a service brake action, is configured to provide pressure in the axial direction against a central portion of said set of friction elements 350 arranged radially between the inner circumference and outer circumference of said set of friction elements 350.
Aspect 7A. The brake arrangement according to any of aspects 1A-6A, wherein said parking brake piston device 370 is ring shaped and configured to be coaxially arranged around said brake axle 340 radially externally relative to said service brake piston device 360, said parking brake piston device 370, in connection to a parking brake action, being configured to provide pressure in the axial direction against a radially outer portion of said set of friction elements 350 so as to optimize the parking brake torque.
Aspect 8A. The brake arrangement according to any of aspects 1A-7A, wherein said brake arrangement further comprises a spring device 380, wherein said parking brake piston device 370 is arranged between and in connection to said spring device 380 and set of friction elements 350, wherein said spring device 380, in a non-parking brake activated state, is configured to be compressed by means of providing a hydraulic pressure on said parking brake piston device 370 so that said parking brake piston device 370 acts on said spring device 380 and not acts on said set of friction elements 350, and wherein, in connection to a parking brake action, said hydraulic pressure on said parking brake piston device 370 is configured to be removed such that said spring device 380 acts on said parking brake piston device 370 by means of a spring force so that said parking brake piston device 370 acts on said set of friction elements 350 so as to provide a parking brake activated state.
Aspect 9A. The brake arrangement according to aspect 8A, wherein said spring device 380 has a ring shaped configuration, said spring device 380 comprising a set of spring members configured to be distributed around said brake axle 340 in connection to said ring shaped parking brake piston device 370.
Aspect 10A. The brake arrangement according to any of aspects 1A-9A, wherein said service brake piston device 360 and parking brake piston device 370 are configured to be arranged relative to each other so that both the service brake piston device 360 and the parking brake piston device 370 may act directly against an axially outermost friction element 351 of said set of friction elements 350 so as to facilitate independent operation of the service brake piston device 360 and parking brake piston device 370.
Aspect 11A. A track assembly comprising a brake arrangement according to any of preceding aspects.
Aspect 12A. A tracked vehicle V comprising at least one track assembly T1, T2 according to aspect 11A.
Aspect 13A. A tracked vehicle V according to aspect 12A, wherein said tracked vehicle comprises a left track assembly T1, a right track assembly T2 and a vehicle body 5, wherein said track assemblies T1, T2 are suspendedly arranged to said vehicle body by means of a suspension arrangement S1, S2.

1. A brake arrangement for a tracked vehicle, wherein the brake arrangement comprises a brake housing, said brake arrangement being configured to be journaled in bearings in connection to a drive unit driven drive axle so as to allow rotation of said drive axle relative to said brake housing, said drive axle being configured to rotate a drive wheel member for a track assembly of a tracked vehicle, said brake arrangement comprising a set of friction elements configured to be arranged about said drive axle, said set of friction elements being configured to be pressed together in the axial direction for providing a braking function in connection to said drive axle, wherein said set of friction elements comprises a first end friction element being the outermost friction element against which pressure is configured to be provided for said braking function, said first end friction element having a thickness in the axial direction which is thicker than the remaining set of friction elements so as to facilitate distributing an even pressure on said set of friction elements when said set of friction elements are pressed together for efficient friction braking function.

2. The brake arrangement of claim 1, said brake arrangement further comprising a hollow brake axle configured to be arranged around said drive axle so that the brake axle is rotated by means of said drive axle, wherein said brake housing is configured to be journaled in bearings to said brake axle such that said journaling in bearings in connection to said drive axle is provided when said brake arrangement is connected to said drive axle.

3. The brake arrangement of claim 2, comprising a bearing configuration for providing said journaling in bearings of said brake housing in connection to said brake axle, said bearing configuration comprising a first bearing member and a second bearing member arranged at an axial distance from said first bearing member, wherein one of said bearing members is provided with a flange configuration for holding the brake housing in the axial direction and the other of said bearing members is configured to allow certain axial movement of said housing relative to said brake axle.

4. The brake arrangement of claim 3, wherein said first bearing member is arranged in connection to a first end portion of said brake housing and said second bearing member is arranged in connection to a second end portion of said brake housing, axially opposite to said first end portion, and wherein said first and second bearing members are cylindrical roller bearing members.

5. The brake arrangement of claim 1, wherein said brake housing has an end wall portion, wherein said set of friction elements are arranged in connection to said end wall portion such that said end wall portion and set of friction elements provides a friction arrangement for providing said braking.

6. The brake arrangement according to claim 5, wherein said end wall portion has an inner side facing said set of friction elements such that a second end element of said set of friction elements, farthest away from said first end element, is arranged in connection to said inner side of said end wall portion, such that when said set of friction elements are pressed together in the axial direction for providing a braking function, said second end element is pressed against said inner side of said end wall portion.

7. The brake arrangement of claim 1, wherein said set of friction elements comprises a first set of elements configured to be engaged to said brake housing and a second set of elements configured to be attached to said to said brake axle for allowing rotation of said second set of elements relative to said first set of elements, wherein said first set of elements and second set of elements are alternatingly arranged relative to each other.

8. The brake arrangement of claim 1, said brake arrangement further comprising a service brake piston device arranged in connection to said set of friction elements, said service brake piston device being configured to act on said set of friction elements based on a brake action so as to press said elements together for providing a braking function for braking rotation of said drive axle so as to brake drive wheel member for stopping drive of a vehicle provided with said brake arrangement.

9. The brake arrangement of claim 8, further comprising a channel configuration within said housing, said channel configuration comprising at least one channel in connection to said service brake piston device, said service brake piston device being configured to receive, in connection to a braking action, pressurized fluid via said at least one channel such that said service brake piston device acts on said set of friction elements.

10. The brake arrangement of claim 9, wherein said service brake piston device is ring shaped and configured to be coaxially arranged around said brake axle.

11. The brake arrangement of claim 1, said brake arrangement further comprising a parking brake piston device arranged in connection to said set of friction elements, said parking brake piston device being configured to act on said set of friction elements based on a parking brake action indicating parking of a vehicle for pressing said elements together for providing a parking brake function for preventing rotation of said drive axle so as to provide a parking brake activated state, preventing movement of wheel member for keeping a vehicle provided with said brake arrangement in a parked position.

12. The brake arrangement of claim 11, wherein said parking brake piston device is ring shaped and configured to be coaxially arranged around said brake axle radially externally relative to said service brake piston device, said parking brake piston device being configured to provide pressure in the axial direction against a radially outer portion of said set of friction elements so as to optimize the parking brake torque.

13. The brake arrangement of claim 11, wherein said brake arrangement further comprises a spring device arranged in connection to said parking brake piston device, wherein said spring device, in a non-parking brake activated state, is configured to be compressed by means of providing a hydraulic pressure on said spring device so that said parking brake piston device does not act on said set of friction elements, and wherein, in connection to a parking brake action, said hydraulic pressure on said spring device is configured to be removed such that said spring device acts on said parking brake piston device by means of a spring force so that said parking brake piston device acts on said set of friction elements so as to provide a parking brake activated state.

14. The brake arrangement of claim 13, wherein said parking brake piston device is configured to receive, in connection to a non-parking brake activated state, pressurized fluid via at least one channel of said channel configuration, such that said parking brake piston device acts on said spring device for providing said compressed state of said spring device.

15. The brake arrangement of claim 13, wherein, in connection to an unexpected loss of hydraulic pressure associated with a parking brake operation of said brake arrangement, said hydraulic pressure providing said compressed sate of said spring device is configured to be removed such that said spring device acts on said parking brake piston device by means of a spring force so as to provide a parking brake activated state.

16. The brake arrangement of claim 13, wherein said spring device has a ring shaped configuration, said spring device comprising a set of spring members configured to be distributed around said brake axle in connection to said ring shaped parking brake piston device.

17. The brake arrangement of claim 13, wherein said brake arrangement further comprises an adjustment device arranged in connection to said spring device axially opposite to said parking brake piston device, said adjustment device being configured to facilitate axial adjustment of said spring device based on the axial position of said parking brake piston device.

18. The brake arrangement of claim 17, wherein said brake arrangement further comprises an opening running from a portion of said housing to said parking brake piston device and configured to receive a measure pin so as to determine position of said parking brake piston device relative to said portion of said housing so as to determine whether there is a need for axial adjustment of said spring device.

19. A track assembly comprising a brake arrangement of claim 1.

20. A tracked vehicle comprising a brake arrangement of claim 1.

21. A tracked vehicle comprising at least one track assembly according to claim 19.
